(19) United States
(12) Patent Application Publication
(10) Pub. No.: US 2026/0350286 A1
(43) Pub. Date: Nov. 5, 2026

(54) METHOD AND DEVICE FOR THROUGH-SILICON VIA MODELING, AND STORAGE MEDIUM

(71) Applicant: INSTITUTE OF MICROELECTRONICS, CHINESE ACADEMY OF SCIENCES, Beijing (CN)

(72) Inventors: Yajuan Su, Beijing (CN); Yuqin Wang, Beijing (CN); Yayi Wei, Beijing (CN)

(21) Appl. No.: 19/384,817

(22) Filed: Nov. 10, 2025

(30) Foreign Application Priority Data
Apr. 18, 2025 (CN) 202510491084.1

(51) Int. Cl. G06F 30/367; G06F 30/392; G06F 30/3953; G06F 111/06; G06F 111/10; G06F 113/18

(52) U.S. Cl. CPC G06F 30/367; G06F 30/392; G06F 30/3953; G06F 2111/06; G06F 2111/10; G06F 2113/18

(57) ABSTRACT

A method for through-silicon via (TSV) modeling, including: building a TSV model set; calculating transmission line characteristic parameters of TSV model pairs and ellipsoidal bumps in the TSV model set to obtain a first calculated parameter, a second calculated parameter, a third calculated parameter, and a fourth calculated parameter; performing simulations on the TSV model pairs and the ellipsoidal bumps to obtain a first simulation parameter, a second simulation parameter, a third simulation parameter, and a fourth simulation parameter; calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and outputting the TSV model set in response to all the parameter differences meeting an error requirement.

### CROSS-REFERENCE TO RELATED APPLICATIONS

The present application claims priority to Chinese Patent Application No. 202510491084.1, titled “METHOD AND DEVICE FOR THROUGH-SILICON VIA MODELING, AND STORAGE MEDIUM,” filed on Apr. 18, 2025 with the China National Intellectual Property Administration, which is incorporated herein by reference in its entirety.

### FIELD

The present disclosure relates to the technical field of integrated circuits, and in particular to a method and a device for through-silicon via modeling, and a storage medium.

### BACKGROUND

Through-silicon via (TSV) modeling is of great significance in modern semiconductor packaging technologies, especially in three-dimensional integrated circuits (3D-ICs) and high-density integrated packaging. As integrated circuits continue to decrease in size and increase in functionality, traditional planar packaging and interconnection technologies struggle to meet demands for higher performance and smaller sizes. TSV, as an efficient vertical interconnection technology, provides an ideal solution for high-speed, low-power, and high-density connections between chips. Due to the structural complexity of TSV and the substantial impact of TSV on chip performance, TSV modeling and simulation are particularly crucial. Nevertheless, the accuracy of current TSV modeling and simulation is relatively low, which may lead to inaccurate predictions for important factors such as packaging performance and reliability.

As a result, improving the accuracy of TSV modeling and simulation is an urgent issue that those skilled in the art need to address.

### SUMMARY

In view of the above issue, a method, an apparatus, and a device for through-silicon via (TSV) modeling, and a storage medium are provided according to the present disclosure, to improve the accuracy of TSV modeling and simulation.

Technical solutions are disclosed as follows according to embodiments of the present disclosure.

A method for TSV modeling is provided, including:
building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

In an embodiment, the first calculated parameter includes a resistance, an inductance, a capacitance, and a conductance of the cylindrical TSV model pair, where
the inductance of the cylindrical TSV model pair is calculated by: L_{C-TSV}=L_{in,C-TSV}+L_{ext,C-TSV}, L_{C-TSV} represents the inductance of the cylindrical TSV model pair, L_{in,C-TSV} represents an internal inductance of the cylindrical TSV body related with current distribution, and is expressed as:

$${L}_{in , C - TSV} = \frac{{μ}_{0} {μ}_{Cu} {h}_{C - TSV}}{8 π} ,$$

μ₀ representing a permeability of vacuum and μ₀=4π×10⁻⁷ H/m, μ_{Cu} representing a permeability of copper, and h_{C-TSV} representing a height of the cylindrical TSV body, and L_{ext,C-TSV} represents an external inductance of the cylindrical TSV body unrelated with a frequency, and is expressed as:

$${L}_{ext , C - TSV} = \frac{{μ}_{0} {μ}_{Cu}}{2 π} [ {h}_{C - TSV} ln ( \frac{{h}_{C - TSV} + \sqrt{{h}_{C - TSV}^{2} + {r}_{C - TSV}^{2}}}{{r}_{C - TSV}} + {r}_{C - TSV} - \sqrt{{h}_{C - TSV}^{2} + {r}_{C - TSV}^{2}} ] ,$$

r_{C-TSV} representing a radius of the cylindrical TSV body.

In an embodiment, the second calculated parameter includes a resistance, an inductance, a capacitance, and a conductance of the tapered TSV model pair, and the capacitance of the tapered TSV model pair is calculated based on a capacitance of an isolation layer of the tapered TSV model pair, a capacitance of a substrate of the tapered TSV model pair, and an equivalent circuit diagram of the tapered TSV model pair, where
the resistance of the tapered TSV model pair is calculated by:

$${R}_{T - TSV} = \sqrt{{R}_{ac , T - TSV}^{2} + {R}_{dc , T - TSV}^{2}} ,$$

R_{T-TSV} represents the resistance of the tapered TSV model pair, R_{ac,T-TSV} represents a high-frequency alternating-current resistance of the tapered TSV model pair and is expressed as:

$${R}_{ac , T - TSV} = \frac{{ρ}_{C u} ( 2 + {β}^{2} )}{4 πβδ} ln [ 1 + \frac{2 {h}_{T - TSV} β}{( 2 {r}_{a} - δ )} ] ,$$

ρ_{Cu} representing a resistivity of copper, β=tan θ_{T-TSV}, θ_{T-TSV} representing a taper inclination angle of the tapered TSV body, δ representing a skin depth,

$$δ = \sqrt{\frac{{ρ}_{Cu}}{{π f μ}_{0} {μ}_{Cu}}} ,$$

f representing an operating frequency of the tapered TSV body, rₐ representing a radius of a bottom of the tapered TSV body, rₐ=r_{T-TSV}−βh_{T-TSV}, r_{T-TSV} representing a radius of a top of the tapered TSV body, and h_{T-TSV} representing a height of the tapered TSV body, and R_{dc,T-TSV} represents a low-frequency direct-current resistance of the tapered TSV model pair and is expressed as:

$$\\ {R}_{dc , T - TSV} = \frac{{ρ}_{Cu} {h}_{T - TSV} ( 1 + 0.5 \times {β}^{2} )}{π {r}_{a} ( {r}_{a} + β {h}_{T - TSV} )} ;$$

in a case that β is less than 0.1, the inductance of the tapered TSV model pair is calculated by: L_{T-TSV}=L_{in,T-TSV}+L_{ext,T-TSV}, L_{T-TSV} represents the inductance of the tapered TSV model pair, L_{in,T-TSV} represents an internal inductance of the tapered TSV model pair and is expressed as:

$$\\ {L}_{in , T - TSV} = \frac{{μ}_{0} {μ}_{Cu}}{2 π} [ \frac{{h}_{T - TSV}}{4} + {h}_{T - TSV} ln \frac{\sqrt{{h}_{T - TSV}^{2} + {r}_{a}^{2} + {h}_{T - TSV}}}{{r}_{a}} + {r}_{a} - \sqrt{{h}_{T - TSV}^{2} + {r}_{a}^{2}} + \frac{2 {h}_{T - TSV} β ( {h}_{T - TSV}^{2} - ( {h}_{T - TSV} + {r}_{a} ) ( \sqrt{{h}_{T - TSV}^{2} + {r}_{a}^{2}} - {r}_{a} ) )}{( \sqrt{{h}_{T - TSV}^{2} + {r}_{a}^{2}} - {r}_{a} ) ( 4 {r}_{a} + {h}_{T - TSV} β )} ] ,$$

and L_{ext,T-TSV} represents an external inductance of the tapered TSV model pair and is expressed as:

$$\\ {L}_{ext , T - TSV} = \frac{{μ}_{0} {μ}_{Cu}}{2 π} [ {h}_{T - TSV} ln \frac{\sqrt{{h}_{T - TSV}^{2} + {p}_{T - TSV}^{2} + {h}_{T - TSV}}}{{p}_{T - TSV}} + {p}_{T - TSV} - \sqrt{{h}_{T - TSV}^{2} + {p}_{T - TSV}^{2}} + \frac{2 {h}_{T - TSV} β ( {h}_{T - TSV}^{2} - ( {h}_{T - TSV} + {p}_{T - TSV} ) ( \sqrt{{h}_{T - TSV}^{2} + {p}_{T - TSV}^{2}} - {p}_{T - TSV} ) )}{( \sqrt{{h}_{T - TSV}^{2} + {p}_{T - TSV}^{2}} - {p}_{T - TSV} ) ( 4 {p}_{T - TSV} + {h}_{T - TSV} β )} ] ,$$

p_{T-TSV} representing a distance between tapered TSV bodies of the two tapered TSV models in the tapered TSV model pair;
the capacitance of the isolation layer of the tapered TSV model pair is calculated by:

$$\\ {C}_{ox , T - TSV} = 2 π {ε}_{0} {ε}_{{SiO}_{2}} \times \{ \frac{{h}_{T - TSV}}{ln ( \frac{{r}_{a} + {t}_{ox}}{{r}_{a}} )} + \frac{β {t}_{ox} {h}_{T - TSV}^{2}}{2 {{r}_{a} ( {r}_{a} + {t}_{ox} ) [ ln ( \frac{{r}_{a} + {t}_{ox}}{{r}_{a}} ) ]}^{2}} \} ,$$

ε₀ representing a permittivity of vacuum, ε_{SiO}_{₂} representing a relative permittivity of silicon dioxide, tₒₓ representing a thickness of the isolation layer of silicon dioxide, and tₒₓ=0.1 micrometer; and the capacitance of the substrate of the tapered TSV model pair is calculated by:

$$\\ {C}_{Si , T - TSV} = 2 π {ε}_{0} {ε}_{Si} \times \{ \frac{{h}_{T - TSV}}{{cosh}^{- 1} ( \frac{{p}_{T - TSV}^{2}}{2 {( {r}_{a} + {t}_{ox} )}^{2}} - 1 )} - \frac{β {h}_{T - TSV}^{2} {p}_{T - TSV} ( \frac{2 {( {r}_{a} + {t}_{ox} )}^{2} - {p}_{T - TSV}^{2}}{\sqrt{{p}_{T - TSV}^{2} - 4 {( {r}_{a} + {t}_{ox} )}^{2}}} - {p}_{T - TSV} )}{4 {{r}_{a}^{3} [ {cosh}^{- 1} ( \frac{{p}_{T - TSV}^{2}}{2 {( {r}_{a} + {t}_{ox} )}^{2}} - 1 ) ]}^{2} [ \frac{{p}_{T - TSV}^{2}}{2 {( {r}_{a} + {t}_{ox} )}^{2}} - 1 + \sqrt{{( \frac{{p}_{T - TSV}^{2}}{2 {( {r}_{a} + {t}_{ox} )}^{2}} - 1 )}^{2} - 1} ]} \} ,$$

ε_{Si} representing a relative permittivity of silicon.

In an embodiment, the third calculated parameter includes a resistance, an inductance, a capacitance, and a conductance of the reentrant TSV model pair, and the capacitance of the reentrant TSV model pair is calculated based on a capacitance of an isolation layer of the reentrant TSV model pair, a capacitance of a substrate of the reentrant TSV model pair, and an equivalent circuit diagram of the reentrant TSV model pair, where
the resistance of the reentrant TSV model pair is calculated by:

$$\\ {R}_{R - TSV} = \sqrt{{R}_{ac , R - TSV}^{2} + {R}_{dc , R - TSV}^{2}} ,$$

R_{R-TSV} represents the resistance of the reentrant TSV model pair, R_{ac,R-TSV} represents a high-frequency alternating-current resistance of the reentrant TSV model pair and is expressed as:

$$\\ {R}_{ac , R - TSV} = \frac{{ρ}_{Cu} ( 2 + {α}^{2} )}{4 π α δ} ln [ 1 + \frac{2 {c}_{1} {h}_{R - TSV} α}{( 2 {r}_{b} - δ )} ] + \frac{{ρ}_{Cu} {c}_{2} {h}_{R - TSV}}{π [ {r}_{b}^{2} - {( {r}_{b} - δ )}^{2} ]} ,$$

c₁ and c₂ representing a ratio of a height of a cylindrical part in the reentrant TSV body to a height of the reentrant TSV body and a ratio of a height of a tapered part in the reentrant TSV body to the height of the reentrant TSV body, respectively, α=tan θ_{R-TSV}, θ_{R-TSV} representing a taper inclination angle of the tapered part in the reentrant TSV body, h_{R-TSV} representing the height of the reentrant TSV body, r_{b} representing a radius of the cylindrical part in the reentrant TSV body, r_{b}=r_{R-TSV}−αC₂h_{R-TSV}, and r_{R-TSV} representing a radius of a top of the tapered part in the reentrant TSV body, and R_{dc,R-TSV} represents a low-frequency direct-current resistance of the reentrant TSV model pair and is expressed as:

$$\\ {R}_{dc , R - TSV} = \frac{{ρ}_{Cu} {c}_{1} {h}_{R - TSV} ( 1 + 0.5 \times {α}^{2} )}{π {r}_{T - TSV} ( {r}_{b} + {c}_{1} α {h}_{R - TSV} )} + \frac{{ρ}_{Cu} {c}_{2} {h}_{R - TSV}}{{πr}_{b}^{2}} ;$$

in a case that β is less than 0.1, the inductance of the reentrant TSV model pair is calculated by: L_{R-TSV}=L_{in,R-TSV}+L_{ext,R-TSV}, L_{R-TSV} represents the inductance of the reentrant TSV model pair, L_{in,R-TSV} represents an internal inductance of the reentrant TSV model pair and is expressed as:

$$\\ {L}_{in , R - TSV} = \frac{{μ}_{0} {μ}_{Cu} {c}_{1} {h}_{R - TSV}}{8 π} + \frac{{μ}_{0} {μ}_{Cu}}{2 π} [ \frac{{c}_{2} {h}_{R - TSV}}{4} + {h}_{T - TSV} ln \frac{\sqrt{{( {c}_{2} {h}_{R - TSV} )}^{2} + {r}_{b}^{2} + {c}_{2} {h}_{R - TSV}}}{{r}_{a}} + {r}_{a} - \sqrt{{( {c}_{2} {h}_{R - TSV} )}^{2} + {r}_{b}^{2}} + \frac{2 {c}_{2} {h}_{R - TSV} β ( {( {c}_{2} {h}_{R - TSV} )}^{2} - ( {c}_{2} {h}_{R - TSV} + {r}_{b} ) ( \sqrt{{( {c}_{2} {h}_{R - TSV} )}^{2} + {r}_{b}^{2}} - {r}_{b} ) )}{( \sqrt{{( {c}_{2} {h}_{R - TSV} )}^{2} + {r}_{b}^{2}} - {r}_{b} ) ( 4 {r}_{b} + {c}_{2} {h}_{R - TSV} α )} ] ,$$

and L_{ext,R-TSV} represents an external inductance of the reentrant TSV model pair and is expressed as:

$$\\ {L}_{ext , R - TSV} = \frac{{μ}_{0} {μ}_{Cu}}{2 π} [ {c}_{1} {h}_{R - TSV} ln ( \frac{{c}_{1} {h}_{R - TSV} + \sqrt{{h}_{C - TSV}^{2} + {r}_{b}^{2}}}{{r}_{b}} ) + {r}_{b} - \sqrt{{( {c}_{1} {h}_{R - TSV} )}^{2} + {r}_{b}^{2}} ] + \frac{{μ}_{0} {μ}_{Cu}}{2 π} [ {c}_{2} {h}_{R - TSV} ln \frac{\sqrt{{( {c}_{2} {h}_{R - TSV} )}^{2} + {p}_{R - TSV}^{2} + {c}_{2} {h}_{R - TSV}}}{{p}_{R - TSV}} + {p}_{R - TSV} - \sqrt{{( {c}_{2} {h}_{R - TSV} )}^{2} + {p}_{R - TSV}^{2}} + \frac{2 {c}_{2} {h}_{R - TSV} α ( {( {c}_{2} {h}_{R - TSV} )}^{2} - ( {c}_{2} {h}_{R - TSV} + {p}_{T - TSV} + {p}_{T - TSV} ) ( \sqrt{{( {c}_{2} {h}_{R - TSV} )}^{2} + {p}_{R - TSV}^{2}} - {p}_{R - TSV} ) )}{( \sqrt{{( {c}_{2} {h}_{R - TSV} )}^{2} + {p}_{R - TSV}^{2}} - {p}_{R - TSV} ) ( 4 {p}_{R - TSV} + {c}_{2} {h}_{R - TSV} α )} ] ,$$

P_{R-TSV} representing a distance between reentrant TSV bodies of the two reentrant TSV models in the reentrant TSV model pair;
the capacitance of the isolation layer of the reentrant TSV model pair is calculated by:

$$\\ {C}_{ox , T - TSV} = 2 π {ε}_{0} {ε}_{{SiO}_{2}} \times \{ \frac{{c}_{2} {h}_{R - TSV}}{ln ( \frac{{r}_{b} + {t}_{ox}}{{r}_{b}} )} + \frac{α {{t}_{ox} ( {c}_{2} {h}_{R - TSV} )}^{2}}{2 {{r}_{b} ( {r}_{b} + {t}_{ox} ) [ ln ( \frac{{r}_{b} + {t}_{ox}}{{r}_{b}} ) ]}^{2}} \} + \frac{2 π {ε}_{0} {ε}_{{SiO}_{2}} {c}_{1} {h}_{R - TSV}}{ln ( \frac{{r}_{b} + {t}_{ox}}{{r}_{b}} )} ;$$

the capacitance of the substrate of the reentrant TSV model pair is calculated by:

$$\\ {C}_{Si , T - TSV} = 2 {πε}_{0} {ε}_{Si} \times \{ \frac{{c}_{2} {h}_{R - TSV}}{{cosh}^{- 1} ( \frac{{p}_{R - TSV}^{2}}{2 {( {r}_{b} + {t}_{ox} )}^{2}} - 1 )} - \frac{{α ( {c}_{2} {h}_{R - TSV} )}^{2} {p}_{T - TSV} ( \frac{2 {( {r}_{b} + {t}_{ox} )}^{2} - {p}_{R - TSV}^{2}}{\sqrt{{p}_{R - TSV}^{2} - 4 {( {r}_{b} + {t}_{ox} )}^{2}}} - {p}_{R - TSV} )}{4 {{r}_{b}^{3} [ {cosh}^{- 1} ( \frac{{p}_{R - TSV}^{2}}{2 {( {r}_{b} + {t}_{ox} )}^{2}} - 1 ) ]}^{2} [ \frac{{p}_{R - TSV}^{2}}{2 {( {r}_{b} + {t}_{ox} )}^{2}} - 1 + \sqrt{{( \frac{{p}_{R - TSV}^{2}}{2 {( {r}_{b} + {t}_{ox} )}^{2}} - 1 )}^{2} - 1} ]} \} + \frac{2 π {ε}_{0} {ε}_{Si} {c}_{1} {h}_{R - TSV}}{ln ( \frac{{p}_{R - TSV}}{2 {r}_{b}} + \sqrt{{( \frac{{p}_{R - TSV}}{2 {r}_{b}} )}^{2} - 1} )} .$$

In an embodiment, the fourth calculated parameter includes a transmission line characteristic parameter of the first ellipsoidal bump in the cylindrical TSV model pair, a transmission line characteristic parameter of the second ellipsoidal bump in the tapered TSV model pair, and a transmission line characteristic parameter of the third ellipsoidal bump in the reentrant TSV model pair, the transmission line characteristic parameter of the first ellipsoidal bump in the cylindrical TSV model pair includes a resistance, an inductance, a capacitance, and a conductance of the first ellipsoidal bump in the cylindrical TSV model pair, the transmission line characteristic parameter of the second ellipsoidal bump in the tapered TSV model pair includes a resistance, an inductance, a capacitance, and a conductance of the second ellipsoidal bump in the tapered TSV model pair, and the transmission line characteristic parameter of the third ellipsoidal bump in the reentrant TSV model pair includes a resistance, an inductance, a capacitance, and a conductance of the third ellipsoidal bump in the reentrant TSV model pair, where
for each of the first ellipsoidal bump in the cylindrical TSV model pair, the second ellipsoidal bump in the tapered TSV model pair, and the third ellipsoidal bump in the reentrant TSV model pair,
   a capacitance of the ellipsoidal bump is calculated by:

$$\\ {C}_{Bump} = \frac{1}{2} {C}_{Bump 1} ,$$

C_{Bump1} represents a half-capacitance of the ellipsoidal bump, and

$$\\ {C}_{Bump 1} = π {ε}_{0} {ε}_{underfill} \times \{ \frac{{h}_{Bump}}{{cosh}^{- 1} ( \frac{{p}_{TSV}^{2}}{2 {( {r}_{Bump} )}^{2}} - 1 )} \} ,$$

h_{Bump} representing a height of the ellipsoidal bump, r_{Bump} representing a radius of the ellipsoidal bump, p_{TSV} representing a distance between two TSV bodies in the corresponding TSV model pair, and ε_{underfill} representing a relative permittivity of an underfill.

In an embodiment, each of the first ellipsoidal bump in the cylindrical TSV model pair, the second ellipsoidal bump in the tapered TSV model pair, and the third ellipsoidal bump in the reentrant TSV model pair has a diameter of 25 micrometers, a radius of 12.5 micrometers, and a height of 18 micrometers.

In an embodiment, any one TSV body in the cylindrical TSV model pair, in the tapered TSV model pair, and in the reentrant TSV model pair is surrounded by an isolation layer, a material of the isolation layer is silicon dioxide, and a thickness of the isolation layer is 0.1 micrometer.

An apparatus for TSV modeling is provided, including:
a building unit, configured for building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
a first calculation unit, configured for calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
a simulation unit, configured for performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
a second calculation unit, configured for calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
an output unit, configured for outputting the TSV model set in response to all the parameter differences meeting an error requirement.

A device for TSV modeling is provided, including: a memory, a processor, and a computer program stored on the memory and executable on the processor.

The processor, when executing the computer program, performs:
building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

A computer-readable storage medium is provided. The computer-readable storage medium stores instructions. The instructions, when being executed on a terminal device, cause the terminal device to perform:
building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

A method, an apparatus, and a device for TSV modeling, and a storage medium are provided according to the present disclosure. Firstly, a TSV model set including an actual form of an ellipsoidal bump is built, and transmission line characteristic parameters of a cylindrical TSV model pair, a tapered TSV model pair, a reentrant TSV model pair, and ellipsoidal bumps in the cylindrical TSV model pair, in the tapered TSV model pair, and in the reentrant TSV model pair are respectively calculated, to obtain a first calculated parameter, a second calculated parameter, a third calculated parameter, and a fourth calculated parameter. Next, simulations are performed on the above TSV model pairs and the ellipsoidal bumps to obtain a first simulation parameter, a second simulation parameter, a third simulation parameter, and a fourth simulation parameter. Finally, by comparing parameter differences between the calculated parameters and the simulation parameters, a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter are calculated to evaluate the accuracy of the TSV model set and the reliability of simulation results. In response to all the parameter differences meeting an error requirement, the TSV model set is outputted.

### BRIEF DESCRIPTION OF THE DRAWINGS

For more clearly illustrating embodiments of the present disclosure or technical solutions in the related art, drawings referred to describe the embodiments or the related art will be briefly described hereinafter. Apparently, the drawings in the following description are only some embodiments of the present disclosure, and for those skilled in the art, other drawings may be obtained based on these drawings without any creative efforts.

FIG. 1 is a flow chart of a method for through-silicon via (TSV) modeling according to an embodiment of the present disclosure;

FIG. 2a is a three-dimensional (3D) cross-sectional view of a cylindrical TSV model pair according to an embodiment of the present disclosure;

FIG. 2b is a 3D cross-sectional view of a tapered TSV model pair according to an embodiment of the present disclosure;

FIG. 2c is a 3D cross-sectional view of a reentrant TSV model pair according to an embodiment of the present disclosure;

FIG. 3 is an equivalent circuit diagram of a cylindrical TSV model pair according to an embodiment of the present disclosure; and

FIG. 4 is a schematic structural diagram of an apparatus for TSV modeling according to an embodiment of the present disclosure.

### DETAILED DESCRIPTION

In order to facilitate understanding technical solutions provided in the embodiments of the present disclosure, a background related with the embodiments of the present disclosure is described below.

Through-silicon via (TSV) technology is a critically important technology in modern semiconductor packaging, primarily used for achieving electrical connections between different layers or different chips in integrated circuits (ICs). In traditional planar ICs, all electrical connections are generally made on a same plane. However, as ICs continue to decrease in size and increase in performance requirements, single-plane wiring can no longer meet demands, especially in high-performance and low-power applications, and thus three-dimensional integrated circuits (3D-ICs) have gradually become an emerging trend. In order to overcome limitations of planar connections, the TSV technology has emerged, enabling vertical interconnections between different layers.

The TSV technology involves drilling vias into silicon wafers and filling the vias with conductive materials (usually copper or aluminum), to form vertical electrical connection pathways. Such through vias enable high-speed data transmission and power delivery between different layers of a chip, significantly improving the communication speed and performance of the chip. The TSV technology can effectively reduce the distance between chip connections, thereby decreasing the signal transmission delay and enhancing the performance of ICs. With the continuous reduction of chip sizes, the TSV technology has gradually become an indispensable component for 3D-ICs, and especially in fields such as mobile devices, high-performance computing, and high-density memory, the TSV technology can markedly boost system performance and power efficiency.

Although the TSV technology plays an important role in enhancing IC performance, it faces some challenges in modeling and simulation. In current actual applications, ellipsoidal bumps are often simplified into simple cylindrical bumps for modeling, providing certain computational efficiency, but failing to accurately reflect true forms of the ellipsoidal bumps in industry. Compared with the cylindrical bumps, the ellipsoidal bumps have more complex geometric features. The impact of the ellipsoidal bumps on electrical performance, thermal conduction, mechanical stress and the like, especially in large-scale packaging and high-density interconnection scenarios, cannot be accurately captured by employing the cylindrical bumps. Therefore, using simple cylindrical bumps for TSV modeling and simulation yields relatively low precision, which may lead to inaccurate predictions for important factors like packaging performance and reliability.

In order to address this issue, a method, an apparatus, and a device for TSV modeling, and a storage medium are provided according to the embodiments of the present disclosure. Firstly, a TSV model set including a true form of an ellipsoidal bump is built, and transmission line characteristic parameters of a cylindrical TSV model pair, a tapered TSV model pair, a reentrant TSV model pair, and ellipsoidal bumps in the cylindrical TSV model pair, in the tapered TSV model pair, and in the reentrant TSV model pair are respectively calculated, to obtain a first calculated parameter, a second calculated parameter, a third calculated parameter, and a fourth calculated parameter. Next, simulations are performed on the above TSV model pairs and the ellipsoidal bumps to obtain a first simulation parameter, a second simulation parameter, a third simulation parameter, and a fourth simulation parameter. Finally, by comparing parameter differences between the calculated parameters and the simulation parameters, a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter are calculated to evaluate the accuracy of the model and the reliability of simulation results, so as to output an accurate TSV model set. In the present disclosure, by employing the cylindrical, tapered and reentrant TSV model pairs in conjunction with actual geometric features of the ellipsoidal bump, the TSV model set is built, accurately reflecting complex geometric forms in a package, improving modeling accuracy, and enabling accurate simulation of the ellipsoidal bump during electrical performance analysis. In high-density interconnection or large-scale packaging, this accurate modeling method can effectively avoid electrical performance prediction errors caused by geometric simplification, ensuring the reliability of electrical performance analysis results.

In addition, modeling and simulation of a reentrant TSV model, and calculating of a transmission line characteristic parameter of the reentrant TSV model are provided in the present disclosure, accurately reflecting the impact of a reentrant TSV structure on signal transmission, and addressing potential issues in high-frequency applications such as electromagnetic interference, signal reflection, and impedance mismatch caused by the reentrant TSV structure.

The technical solutions in the embodiments of the present disclosure are described clearly and completely in conjunction with the drawings in the embodiments of the present disclosure hereinafter. It is apparent that the described embodiments are only some rather than all embodiments of the present disclosure. All other embodiments obtained by those skilled in the art without any creative efforts based on the embodiments of the present disclosure, fall within the protection scope of the present disclosure.

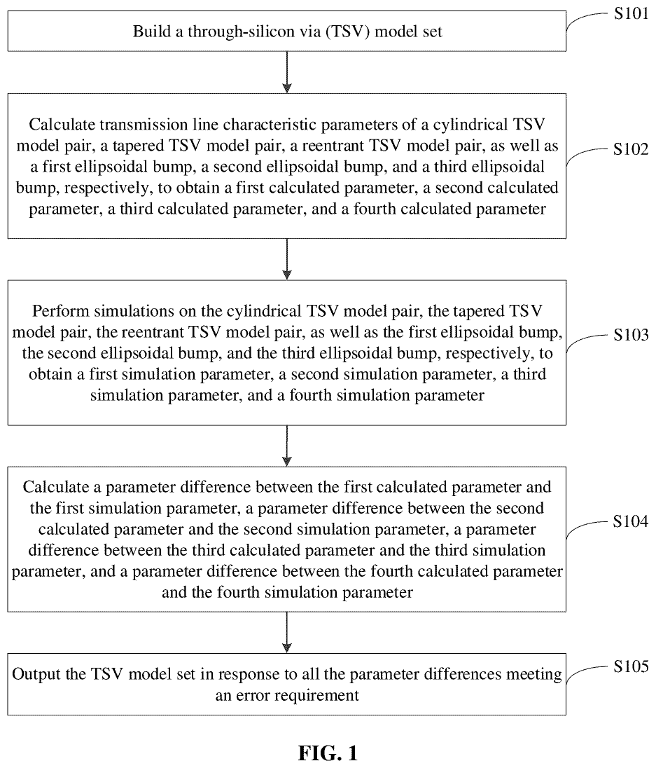

Reference is made to FIG. 1, which is a flow chart of a method for TSV modeling according to an embodiment of the present disclosure. As shown in FIG. 1, the method includes the following steps S101 to S105.

In step S101, a TSV model set is built.

In this step, the TSV model set is built by using TSV model pairs with various geometric forms (cylindrical, tapered, and reentrant forms). The TSV model pairs include through vias with distinct geometric structures for subsequent characteristic analysis.

Specifically, the TSV model set includes a cylindrical TSV model pair, a tapered TSV model pair, and a reentrant TSV model pair.

The cylindrical TSV model pair includes two cylindrical TSV models with a same form. For each of the two cylindrical TSV models, each end of the model is connected to a pad, to simulate contact with other devices or materials in practical applications. A first end of a cylindrical TSV body of the model is connected to a first ellipsoidal bump to ensure a tight and stable connection.

The tapered TSV model pair has a similar structure with the cylindrical TSV model pair, except that its form is tapered. The tapered TSV model pair includes a third pad, a fourth pad, and a second ellipsoidal bump.

The reentrant TSV model pair features a reentrant form, with a similar structure.

Each TSV model includes a TSV body connected to an ellipsoidal bump, and the ellipsoidal bump serves to connect with and support the TSV body through a pad.

In an embodiment, the ellipsoidal bump has a diameter of 25 micrometers (μm), a radius of 12.5 μm, and a height of 18 μm.

It should be noted that, a reentrant TSV body in the present disclosure includes two parts: a tapered part and a cylindrical part.

In an embodiment, sizes of pads in the cylindrical TSV model pair, the tapered TSV model pair, and the reentrant TSV model pair may be, but are not limited to, 20 μm in length, m in width, and 1 μm in height. The pads include a single copper (Cu) pad and a composite pad formed by stacking a copper pad and a nickel (Ni) pad together. The single copper pad is connected to a second end of the TSV body, and the composite pad is connected to a first end of the TSV body, with the copper pad of the composite pad in contact with the TSV body.

In an embodiment, each of the TSV bodies in the cylindrical TSV model pair, in the tapered TSV model pair, and in the reentrant TSV model pair is surrounded by an isolation layer, a material of the isolation layer is silicon dioxide, and a thickness of the isolation layer is 0.1 μm.

In addition, the periphery of the isolation layer surrounding each TSV body in the TSV bodies of the cylindrical TSV model pair, the tapered TSV model pair, and the reentrant TSV model pair is a silicon substrate with a thickness of 30 μm from top to bottom. A dielectric layer with a thickness of 3 μm is disposed in each of the cylindrical TSV model pair, the tapered TSV model pair, and the reentrant TSV model pair.

In an embodiment, one of two TSV models with a same form in any TSV model pair is referred to as a signal TSV, and the other is referred to as a ground TSV. The ground TSV and the signal TSV in any TSV model pair are separated by 50 μm.

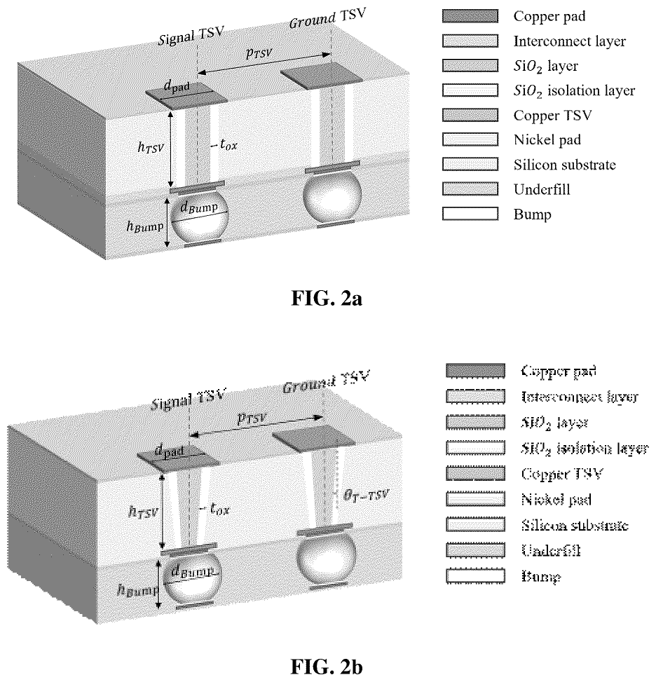

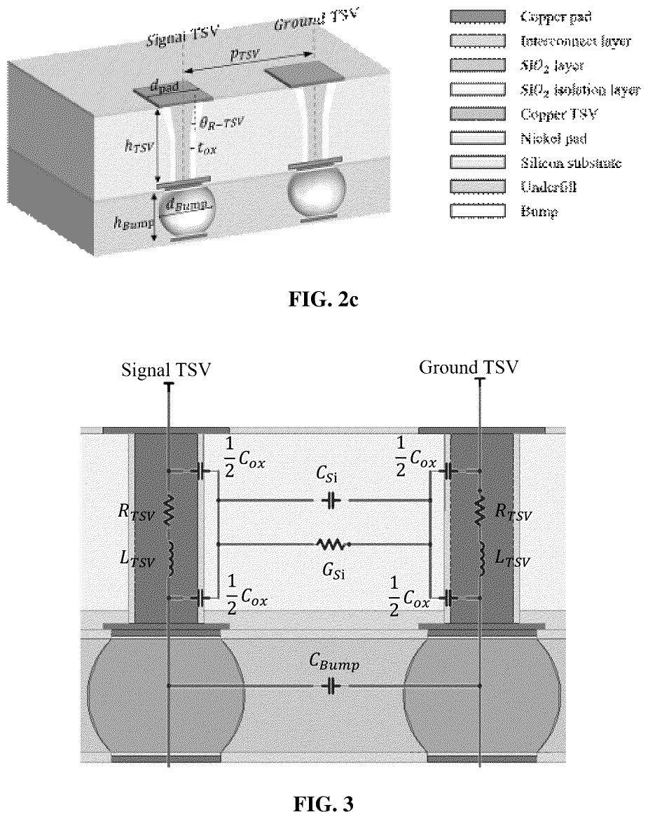

Reference is made to FIGS. 2a-2c, which are three-dimensional (3D) cross-sectional views of a cylindrical TSV model pair, a tapered TSV model pair, and a reentrant TSV model pair, respectively. In FIGS. 2a-2c, h_{TSV} represents a height of the TSV body, p_{TSV} represents a distance between TSV bodies of two TSV models in the TSV model pair, tₒₓ represents a thickness of the isolation layer, d_{pad} represents a length of the pad, h_{Bump} represents a height of the ellipsoidal bump, d_{Bump} represents a diameter of the ellipsoidal bump, θ_{T-TSV} represents a taper inclination angle of the tapered TSV body, and θ_{R-TSV} represents a taper inclination angle of the tapered part of the reentrant TSV body. In FIGS. 2a-2c, the Copper pad represents a copper pad, the Interconnect layer represents a interconnection layer, the SiO₂ layer represents a silicon dioxide layer (that is, the dielectric layer), the SiO₂ isolation layer represents a silicon dioxide isolation layer, the Copper TSV represents a copper TSV, the Nickel pad represents a nickel pad, the Silicon substrate represents a silicon substrate, the Underfill represents an underfill, and the Bump represents a bump.

In an embodiment, different TSV model pairs in the TSV model set have different sizes, and the TSV models in a same TSV model pair have a same size. As shown in Table 1, which lists TSV sizes, C-TSV represents the cylindrical TSV model, T-TSV represents the tapered TSV model, and R-TSV represents the reentrant TSV model.

TABLE 1
TSV Sizes

| Size parameters | C-TSV | T-TSV | R-TSV |
|---|---|---|---|
| TSV top radius (μm) r_{TSV} | 5 | 5 | 5 |
| TSV height (μm) h_{TSV} | 33 | 33 | 33 |
| TSV distance (μm) p_{TSV} | 50 | 50 | 50 |
| Taper inclination angle (degrees) θ_{T-TSV} | / | 2 | 5 |
| Height ratio of cylindrical part:height | / | / | 0.6:0.4 |
| ratio of tapered part c₁:c₂ | | | |

In an embodiment, electrical and thermal parameters of materials used for the models in the TSV model set are identical, as indicated in Table 2. Table 2 shows the electrical and thermal parameters of the materials used for the models, where εᵣ represents a relative permittivity and μᵣ represents a relative permeability.

TABLE 2
Electrical and thermal parameters of materials used for models
Electrical parameters

| | | | Resistivity |
|---|---|---|---|
| Materials | εᵣ | μᵣ | ρ (Ω · m) |
| Copper (Cu) | 1 | 0.99 | 1.72 × 10⁻⁸ |
| Nickel (Ni) | 1 | 600 | 6.90 × 10⁻⁸ |
| Silicon (Si) | 11.9 | 1 | 0.1 |
| Silicon dioxide (SiO₂) | 4 | 1 | / |
| Underfill | 4.3 | 1 | / |
| Bump (Sn—0.7Cu) | 1 | 1 | 1.33 × 10⁻⁷ |

Thermal parameters

| | | Thermal | |
|---|---|---|---|
| | Specific heat | conductivity | Thermal expansion |
| Materials | (J/kg-°C) | (W/m-°C) | coefficient (/°C) |
| Copper (Cu) | 385 | 400 | 1.77 × 10⁻⁵ |
| Nickel (Ni) | 444 | 90 | 1.3 × 10⁻⁵ |
| Silicon (Si) | 712 | 148 | 0 |
| Silicon dioxide (SiO₂) | 745 | 1.5 | 0 |
| Underfill | 1000 | 0.7 | 0 |
| Bump (Sn—0.7Cu) | 230 | 58 | 0 |

In step S102, transmission line characteristic parameters of the cylindrical TSV model pair, the tapered TSV model pair, the reentrant TSV model pair, as well as a first ellipsoidal bump in the cylindrical TSV model pair, a second ellipsoidal bump in the tapered TSV model pair, and a third ellipsoidal bump in the reentrant TSV model pair are respectively calculated to obtain a first calculated parameter, a second calculated parameter, a third calculated parameter, and a fourth calculated parameter.

By performing calculations on the TSV model pairs with different geometric forms (cylindrical, tapered, and reentrant forms) and the ellipsoidal bumps, the transmission line characteristic parameters are obtained. These parameters quantitatively describe TSV performance. Each TSV model pair has a specific calculated parameter for subsequent validation and simulation.

In an embodiment, the first calculated parameter includes a resistance, an inductance, a capacitance, and a conductance of the cylindrical TSV model pair. For the resistance, capacitance, and conductance of the cylindrical TSV model pair, derivation methods in the present disclosure are consistent with those in the related art, which will not be repeated here.

In an embodiment, the inductance of the cylindrical TSV model pair is calculated by: L_{C-TSV}=L_{in,C-TSV}+L_{ext,C-TSV}, L_{C-TSV} represents the inductance of the cylindrical TSV model pair, L_{in,C-TSV} represents an internal inductance of the cylindrical TSV body related with current distribution, and is expressed as:

$$\\ {L}_{in , C - TSV} = \frac{{μ}_{0} {μ}_{Cu} {h}_{C - TSV}}{8 π} ,$$

μ₀ representing a permeability of vacuum and μ₀=4π×10⁻⁷H/m, μ_{Cu} representing a relative permeability of a copper pad, and h_{C-TSV} representing a height of the cylindrical TSV body, and L_{ext,C-TSV} represents an external inductance of the cylindrical TSV body unrelated with a frequency, and is expressed as:

$${L}_{ext , C - TSV} = \frac{{μ}_{0} {μ}_{Cu}}{2 π} [ {h}_{C - TSV} ln ( \frac{{h}_{C - TSV} + \sqrt{{h}_{C - TSV}^{2} + {r}_{C - TSV}^{2}}}{{r}_{C - TSV}} ) + {r}_{C - TSV} - \sqrt{{h}_{C - TSV}^{2} + {r}_{C - TSV}^{2}} ] ,$$

r_{C-TSV} representing a radius of the cylindrical TSV body.

In an embodiment, the second calculated parameter includes a resistance, an inductance, a capacitance, and a conductance of the tapered TSV model pair, and the capacitance of the tapered TSV model pair is calculated based on a capacitance of an isolation layer of the tapered TSV model pair, a capacitance of a substrate of the tapered TSV model pair, and an equivalent circuit diagram of the tapered TSV model pair. For the conductance of the tapered TSV model pair, a derivation method in the present disclosure is consistent with that in the related art, which will not be repeated here.

In an embodiment, the resistance of the tapered TSV model pair is calculated by:

$${R}_{T - TSV} = \sqrt{{R}_{a c , T - T S V}^{2} + {R}_{d c , T - T S V}^{2}} ,$$

R_{T-TSV} represents the resistance of the tapered TSV model pair, R_{ac,T-TSV} represents a high-frequency alternating-current resistance of the tapered TSV model pair and is expressed as:

$${R}_{a c , T - T S V} = \frac{{ρ}_{C u} ( 2 + {β}^{2} )}{4 πβδ} ln [ 1 + \frac{2 {h}_{T - T S V} β}{( 2 {r}_{a} - δ )} ] ,$$

ρ_{Cu} representing a resistivity of copper, β=tan θ_{T-TSV}, θ_{T-TSV} representing a taper inclination angle of the tapered TSV body, δ representing a skin depth,

$$δ = \sqrt{\frac{{ρ}_{Cu}}{π f {μ}_{0} {μ}_{C u}}} ,$$

f representing an operating frequency of the tapered TSV body, rₐ representing a radius of a bottom of the tapered TSV body, rₐ=r_{T-TSV}−βh_{T-TSV}, r_{T-TSV} representing a radius of a top of the tapered TSV body, and h_{T-TSV} representing a height of the tapered TSV body, and R_{dc,T-TSV} represents a low-frequency direct-current resistance of the tapered TSV model pair and is pressed as:

$${R}_{d c , T - T S V} = \frac{{ρ}_{C u} {h}_{T - T S V} ( 1 + 0.5 \times {β}^{2} )}{π {r}_{a} ( {r}_{a} + β {h}_{T - TSV} )} .$$

In a case that β is less than 0.1, the inductance of the tapered TSV model pair is calculated by: L_{T-TSV}=L_{in,T-TSV}+L_{ext,T-TSV}, L_{T-TSV} represents the inductance of the tapered TSV model pair, L_{in,T-TSV} represents an internal inductance of the tapered TSV model pair and is expressed as:

$${L}_{i n , T - T S V} = \frac{{μ}_{0} {μ}_{C u}}{2 π} [ \frac{{h}_{T - T S V}}{4} + {h}_{T - T S V} ln \frac{\sqrt{{h}_{T - TSV}^{2} + {r}_{a}^{2} + {h}_{T - TSV}}}{{r}_{a}} + {r}_{a} - \sqrt{{h}_{T - T S V}^{2} + {r}_{a}^{2}} + \frac{2 {h}_{T - T S V} β ( {h}_{T - TSV}^{2} - ( {h}_{T - TSV} + {r}_{a} ) ( \sqrt{{h}_{T - TSV}^{2} + {r}_{a}^{2}} - {r}_{a} ) )}{( \sqrt{{h}_{T - TSV}^{2} + {r}_{a}^{2}} - {r}_{a} ) ( 4 {r}_{a} + {h}_{T - TSV} β )} ] ,$$

and L_{ext,T-TSV} represents an external inductance of the tapered TSV model pair and is expressed as:

$${L}_{e x t , T - T S V} = \frac{{μ}_{0} {μ}_{C u}}{2 π} [ {h}_{T - T S V} ln \frac{\sqrt{{h}_{T - T S V}^{2} + {p}_{T - TSV}^{2} + {h}_{T - TSV}}}{{p}_{T - TSV}} + {p}_{T - TSV} - \sqrt{{h}_{T - TSV}^{2} + {p}_{T - TSV}^{2}} + \frac{\begin{matrix}2 {h}_{T - T S V} β ( {h}_{T - T S V}^{2} - ( {h}_{T - T S V} + {p}_{T - T S V} ) \\ ( \sqrt{{h}_{T - T S V}^{2} + {p}_{T - T S V}^{2}} - {p}_{T - T S V} ) )\end{matrix}}{( \sqrt{{h}_{T - T S V}^{2} + {p}_{T - T S V}^{2}} - {p}_{T - T S V} ) ( 4 {p}_{T - T S V} + {h}_{T - T S V} β )} ] ,$$

P_{T-TSV} representing a distance between tapered TSV bodies of the two tapered TSV models in the tapered TSV model pair.

The capacitance of the isolation layer of the tapered TSV model pair is calculated by:

$${C}_{o x , T - T S V} = 2 {πε}_{0} {ε}_{S i {O}_{2}} \times \{ \frac{{h}_{T - T S V}}{ln ( \frac{{r}_{a} + {t}_{o x}}{{r}_{a}} )} + \frac{β {t}_{o x} {h}_{T - TSV}^{2}}{2 {{r}_{a} ( {r}_{a} + {t}_{ox} ) [ ln ( \frac{{r}_{a} + {t}_{o x}}{{r}_{a}} ) ]}^{2}} \} ,$$

ε₀ representing a permittivity of vacuum, ε_{SiO}_{₂} representing a relative permittivity of silicon dioxide, tₒₓ representing a thickness of the isolation layer of silicon dioxide, and tₒₓ=0.1 μm.

The capacitance of the substrate of the tapered TSV model pair is calculated by:

$${C}_{Si , T - TSV} = 2 {πε}_{0} {ε}_{Si} \times \{ \frac{{h}_{T - TSV}}{{cos}^{- 1} ( \frac{{p}_{T - TSV}^{2}}{2 {( {r}_{a} + {t}_{ox} )}^{2}} - 1 )} - \frac{β {h}_{T - TSV}^{2} {p}_{T - TSV} ( \frac{2 {( {r}_{a} + {t}_{ox} )}^{2} - {p}_{T - TSV}^{2}}{\sqrt{{p}_{T - TSV}^{2} - 4 {( {r}_{a} + {t}_{ox} )}^{2}}} - {p}_{T - TSV} )}{4 {{r}_{a}^{3} [ {cosh}^{- 1} ( \frac{{p}_{T - TSV}^{2}}{2 {( {r}_{a} + {t}_{ox} )}^{2}} - 1 ) ]}^{2} [ \frac{{p}_{T - TSV}^{2}}{2 {( {r}_{a} + {t}_{ox} )}^{2}} - 1 + \sqrt{{( \frac{{p}_{T - TSV}^{2}}{2 {( {r}_{a} + {t}_{ox} )}^{2}} - 1 )}^{2} - 1} ]} \} ,$$

ε_{Si} representing a relative permittivity of silicon.

In an embodiment, the third calculated parameter includes a resistance, an inductance, a capacitance, and a conductance of the reentrant TSV model pair, and the capacitance of the reentrant TSV model pair is calculated based on a capacitance of an isolation layer of the reentrant TSV model pair, a capacitance of a substrate of the reentrant TSV model pair, and an equivalent circuit diagram of the reentrant TSV model pair. For the conductance of the reentrant TSV model pair, a derivation method in the present disclosure is consistent with that in the related art, which will not be repeated here.

In an embodiment, the resistance of the reentrant TSV model pair is calculated by:

$${R}_{R - T S V} = \sqrt{{R}_{a c , R - T S V}^{2} + {R}_{d c , R - T S V}^{2}} ,$$

R_{R-TSV} represents the resistance of the reentrant TSV model pair, R_{ac,R-TSV} represents a high-frequency alternating-current resistance of the reentrant TSV model pair and is expressed as:

$${R}_{a c , R - TSV} = \frac{{ρ}_{Cu} ( 2 + {α}^{2} )}{4 π αδ} ln [ 1 + \frac{2 {c}_{1} {h}_{R - TSV} α}{( 2 {r}_{b} - δ )} ] + \frac{{ρ}_{Cu} {c}_{2} {h}_{R - TSV}}{π [ {r}_{b}^{2} - {( {r}_{b} - δ )}^{2} ]} ,$$

c₁ and c₂ representing a ratio of a height of a cylindrical part in the reentrant TSV body to a height of the reentrant TSV body and a ratio of a height of a tapered part in the reentrant TSV body to the height of the reentrant TSV body, respectively, α=tan θ_{R-TSV}, θ_{R-TSV} representing a taper inclination angle of the tapered part in the reentrant TSV body, h_{R-TSV} representing the height of the reentrant TSV body, r_{b} representing a radius of the cylindrical part in the reentrant TSV body, r_{b}=r_{R-TSV}−αC₂h_{R-TSV}, and r_{R-TSV} representing a radius of a top of the tapered part in the reentrant TSV body, and R_{dc,R-TSV} represents a low-frequency direct-current resistance of the reentrant TSV model pair and is expressed as:

$${R}_{d c , R - T S V} = \frac{{ρ}_{C u} {c}_{1} {h}_{R - T S V} ( 1 + 0.5 \times {α}^{2} )}{π {r}_{T - TSV} ( {r}_{b} + {c}_{1} α {h}_{R - TSV} )} + \frac{{ρ}_{C u} {c}_{2} {h}_{R - T S V}}{π {r}_{b}^{2}} .$$

It should be noted that in the present disclosure, c₁=0.6 and c₂=0.4. However, the values of the two parameters in modeling may be changed to completely research the performance of the reentrant TSV

In a case that β is less than 0.1, the inductance of the reentrant TSV model pair is calculated by: L_{R-TSV}=L_{in,R-TSV}+L_{ext,R-TSV}, L_{R-TSV} represents the inductance of the reentrant TSV model pair, L_{in,R-TSV} represents an internal inductance of the reentrant TSV model pair and is expressed as:

$${L}_{i n , R - TSV} = \frac{{μ}_{0} {μ}_{Cu} {c}_{1} {h}_{R - TSV}}{8 π} + \frac{{μ}_{0} {μ}_{Cu}}{2 π} [ \begin{matrix}\frac{{c}_{2} {h}_{R - TSV}}{4} + {h}_{T - TSV} ln \frac{\sqrt{{( {c}_{2} {h}_{R - TSV} )}^{2} + {r}_{b}^{2} + {c}_{2} {h}_{R - TSV}}}{{r}_{a}} + {r}_{a} - \\ \sqrt{{( {c}_{2} {h}_{R - TSV} )}^{2} + {r}_{b}^{2}} + \frac{\begin{matrix}2 {c}_{2} {h}_{R - TSV} β ( {( {c}_{2} {h}_{R - TSV} )}^{2} - ( {c}_{2} {h}_{R - TSV} + {r}_{b} ) \\ ( \sqrt{{( {c}_{2} {h}_{R - TSV} )}^{2} + {r}_{b}^{2}} - {r}_{b} ) )\end{matrix}}{( \sqrt{{( {c}_{2} {h}_{R - TSV} )}^{2} + {r}_{b}^{2}} - {r}_{b} ) ( 4 {r}_{b} + {c}_{2} {h}_{R - TSV} α )}\end{matrix} ] ,$$

and L_{ext,R-TSV} represents an external inductance of the reentrant TSV model pair and is expressed as:
p_{R-TSV} representing

$${L}_{e x t , R - T S V} = \frac{{μ}_{0} {μ}_{Cu}}{2 π} [ {c}_{1} {h}_{R - TSV} ln ( \frac{{c}_{1} {h}_{R - TSV} + \sqrt{{h}_{C - TSV}^{2} + {r}_{b}^{2}}}{{r}_{b}} ) + {r}_{b} - \sqrt{{( {c}_{1} {h}_{R - TSV} )}^{2} + {r}_{b}^{2}} ] + \frac{{μ}_{0} {μ}_{Cu}}{2 π} [ {c}_{2} {h}_{R - TSV} ln \frac{\sqrt{{( {c}_{2} {h}_{R - TSV} )}^{2} + {p}_{R - TSV}^{2} + {c}_{2} {h}_{R - TSV}}}{{p}_{R - TSV}} + {p}_{R - TSV} - \sqrt{{( {c}_{2} {h}_{R - TSV} )}^{2} + {p}_{R - TSV}^{2}} + \frac{\begin{matrix}2 {c}_{2} {h}_{R - TSV} α ( {( {c}_{2} {h}_{R - TSV} )}^{2} - ( {c}_{2} {h}_{R - TSV} + {p}_{T - TSV} ) \\ ( \sqrt{{( {c}_{2} {h}_{R - TSV} )}^{2} + {p}_{R - TSV}^{2}} - {p}_{R - TSV} ) )\end{matrix}}{( \sqrt{{( {c}_{2} {h}_{R - TSV} )}^{2} + {p}_{R - TSV}^{2}} - {p}_{R - TSV} ) ( 4 {p}_{R - TSV} + {c}_{2} {h}_{R - TSV} α )} ] ,$$

p_{R-TSV} representing a distance between reentrant TSV bodies of the two reentrant TSV models in the reentrant TSV model pair.

The capacitance of the isolation layer of the reentrant TSV model pair is calculated by:

$${C}_{o x , R - T S V} = 2 {πε}_{0} {ε}_{S i {O}_{2}} \times \{ \frac{{c}_{2} {h}_{R - T S V}}{ln ( \frac{{r}_{b} + {t}_{o x}}{{r}_{b}} )} + \frac{α {{t}_{o x} ( {c}_{2} {h}_{R - T S V} )}^{2}}{2 {{r}_{b} ( {r}_{b} + {t}_{ox} ) [ ln ( \frac{{r}_{b} + {t}_{o x}}{{r}_{b}} ) ]}^{2}} \} + \frac{2 {πε}_{0} {ε}_{{SiO}_{2}} {c}_{1} {h}_{R - T S V}}{ln ( \frac{{r}_{b} + {t}_{o x}}{{r}_{b}} )} .$$

The capacitance of the substrate of the reentrant TSV model pair is calculated by:

$${C}_{Si , R - TSV} = 2 π {ε}_{0} {ε}_{Si} \times \{ \frac{{c}_{2} {h}_{R - TSV}}{{cosh}^{- 1} ( \frac{{p}_{R - TSV}^{2}}{2 {( {r}_{b} + {t}_{ox} )}^{2}} - 1 )} - \frac{{α ( {c}_{2} {h}_{R - TSV} )}^{2} {p}_{T - TSV} ( \frac{2 {( {r}_{b} + {t}_{ox} )}^{2} - {p}_{R - TSV}^{2}}{\sqrt{{p}_{R - TSV}^{2} - 4 {( {r}_{b} + {t}_{ox} )}^{2}}} - {p}_{R - TSV} )}{\begin{matrix}4 {{r}_{b}^{3} [ {cosh}^{- 1} ( \frac{{p}_{R - TSV}^{2}}{2 {( {r}_{b} + {t}_{ox} )}^{2}} - 1 ) ]}^{2} \\ [ \frac{{p}_{R - TSV}^{2}}{2 {( {r}_{b} + {t}_{ox} )}^{2}} - 1 + \sqrt{{( \frac{{p}_{R - TSV}^{2}}{2 {( {r}_{b} + {t}_{ox} )}^{2}} - 1 )}^{2} - 1} ]\end{matrix}} \} + \frac{2 {πε}_{0} {ε}_{Si} {c}_{1} {h}_{R - TSV}}{ln ( \frac{{p}_{R - TSV}}{2 {r}_{b}} + \sqrt{{( \frac{{p}_{R - TSV}}{2 {r}_{b}} )}^{2} - 1 )}} .$$

In an embodiment, the fourth calculated parameter includes a transmission line characteristic parameter of the first ellipsoidal bump in the cylindrical TSV model pair, a transmission line characteristic parameter of the second ellipsoidal bump in the tapered TSV model pair, and a transmission line characteristic parameter of the third ellipsoidal bump in the reentrant TSV model pair, the transmission line characteristic parameter of the first ellipsoidal bump in the cylindrical TSV model pair includes a resistance, an inductance, a capacitance, and a conductance of the first ellipsoidal bump in the cylindrical TSV model pair, the transmission line characteristic parameter of the second ellipsoidal bump in the tapered TSV model pair includes a resistance, an inductance, a capacitance, and a conductance of the second ellipsoidal bump in the tapered TSV model pair, and the transmission line characteristic parameter of the third ellipsoidal bump in the reentrant TSV model pair includes a resistance, an inductance, a capacitance, and a conductance of the third ellipsoidal bump in the reentrant TSV model pair. For the resistance, inductance, and conductance of the ellipsoidal bump, derivation methods in the present disclosure are consistent with those in the related art, which will not be repeated here.

In an embodiment, for each of the first ellipsoidal bump in the cylindrical TSV model pair, the second ellipsoidal bump in the tapered TSV model pair, and the third ellipsoidal bump in the reentrant TSV model pair, a capacitance of the ellipsoidal bump is calculated by:

$${C}_{Bump} = \frac{1}{2} {C}_{Bump 1} ,$$

C_{Bump1} represents a half-capacitance of the ellipsoidal bump, and

$${C}_{Bump 1} = {πε}_{0} {ε}_{underfill} \times \{ \frac{{h}_{Bump}}{{cosh}^{- 1} ( \frac{{p}_{T S V}^{2}}{2 {( {r}_{Bump} )}^{2}} - 1 )} \} ,$$

h_{Bump} representing a height of the ellipsoidal bump, r_{Bump} representing a radius of the ellipsoidal bump, p_{TSV} representing a distance between two TSV bodies in the corresponding TSV model pair, and ε_{underfill} representing a relative permittivity of an underfill.

In step S103, simulations are performed on the cylindrical TSV model pair, the tapered TSV model pair, the reentrant TSV model pair, as well as the first ellipsoidal bump, the second ellipsoidal bump, and the third ellipsoidal bump, to obtain a first simulation parameter, a second simulation parameter, a third simulation parameter, and a fourth simulation parameter.

Transmission characteristics of the TSV model pairs are validated by simulations, to compare against the calculated parameters. During this process, practical situations are simulated to ensure consistency between the calculated parameters and practical situations.

Specifically, simulations are performed on the TSV model pairs (the cylindrical, tapered, and reentrant TSV model pairs) and the ellipsoidal bumps, to obtain simulation results corresponding to the above calculated parameters. Simulation is a means for testing the characteristics that each model may exhibit in reality through computer simulations.

In an embodiment, the first simulation parameter includes a simulation resistance, a simulation inductance, a simulation capacitance, and a simulation conductance of the cylindrical TSV model pair.

In an embodiment, the second simulation parameter includes a simulation resistance, a simulation inductance, a simulation capacitance, and a simulation conductance of the tapered TSV model pair.

In an embodiment, the third simulation parameter includes a simulation resistance, a simulation inductance, a simulation capacitance, and a simulation conductance of the reentrant TSV model pair.

In an embodiment, the fourth simulation parameter includes a simulation transmission line characteristic parameter of the first ellipsoidal bump in the cylindrical TSV model pair, a simulation transmission line characteristic parameter of the second ellipsoidal bump in the tapered TSV model pair, and a simulation transmission line characteristic parameter of the third ellipsoidal bump in the reentrant TSV model pair, the simulation transmission line characteristic parameter of the first ellipsoidal bump in the cylindrical TSV model pair includes a simulation resistance, a simulation inductance, a simulation capacitance, and a simulation conductance of the first ellipsoidal bump in the cylindrical TSV model pair, the simulation transmission line characteristic parameter of the second ellipsoidal bump in the tapered TSV model pair includes a simulation resistance, a simulation inductance, a simulation capacitance, and a simulation conductance of the second ellipsoidal bump in the tapered TSV model pair, and the simulation transmission line characteristic parameter of the third ellipsoidal bump in the reentrant TSV model pair includes a simulation resistance, a simulation inductance, a simulation capacitance, and a simulation conductance of the third ellipsoidal bump in the reentrant TSV model pair.

In step S104, a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter are calculated.

The calculated parameters are compared with the simulation parameters to determine the differences therebetween. The goal of this step is to validate model accuracy and check whether errors between the calculated results and the simulation results are within a reasonable range.

In a case that the differences between the calculated parameters and the simulation parameters meet a preset error requirement, the TSV model set is considered effective and can be used for practical applications.

In step S105, the TSV model set is outputted in response to all the parameter differences meeting an error requirement.

In response to all the parameter differences meeting the error requirement, the final TSV model set is outputted, which indicates that the TSV model set has an accurate performance in transmission characteristics and is applicable for practical designs. However, if some parameter differences fail to meet the error requirement, forms of the models that do not meet the requirement should be adjusted. In an implementation, the geometric forms of the relevant models may be adjusted (for example, sizes, shapes, and the like of the models may be adjusted) based on the parameter differences, and the calculation and simulation may be re-performed (that is, returning to the steps S102 to S105) until all the parameter differences are within an acceptable range, thereby ensuring that the final TSV model set is accurate and reliable in electrical performance.

According to the contents of the steps S101 to S105, a TSV model set including a true form of an ellipsoidal bump is first built, and transmission line characteristic parameters of a cylindrical TSV model pair, a tapered TSV model pair, a reentrant TSV model pair, and ellipsoidal bumps in the cylindrical TSV model pair, in the tapered TSV model pair, and in the reentrant TSV model pair are respectively calculated, to obtain a first calculated parameter, a second calculated parameter, a third calculated parameter, and a fourth calculated parameter. Next, simulations are performed on the above TSV model pairs and the ellipsoidal bumps to obtain a first simulation parameter, a second simulation parameter, a third simulation parameter, and a fourth simulation parameter. On this basis, a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter are calculated. The TSV model set is outputted in response to all the parameter differences meeting a preset error requirement. In the present disclosure, the practice of simplifying the ellipsoidal bump into a cylindrical bump is avoided by employing the cylindrical, tapered, and reentrant TSV model pairs in conjunction with actual geometric features of the ellipsoidal bump. In this way, a complex geometric form of an actual package can be reflected more accurately, and the modeling accuracy can be significantly enhanced. Moreover, TSV models with different forms (for example, the cylindrical, tapered, and reentrant TSV models) allow for accurate electrical performance of the ellipsoidal bumps in various packaging and interconnection structures, further avoiding electrical performance prediction errors caused by the simplification, especially in high-density interconnection or large-scale packaging.

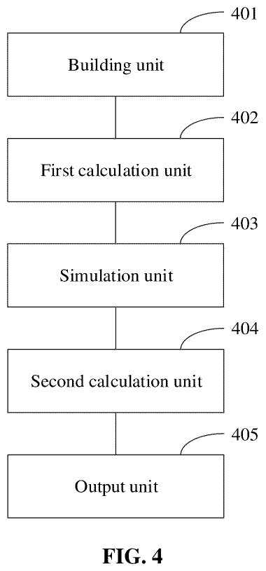

Reference is made to FIG. 4, which is a schematic structural diagram of an apparatus for TSV modeling according to an embodiment of the present disclosure. As shown in FIG. 4, the apparatus includes:
a building unit 401, configured for building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
a first calculation unit 402, configured for calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
a simulation unit 403, configured for performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
a second calculation unit 404, configured for calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
an output unit 405, configured for outputting the TSV model set in response to all the parameter differences meeting an error requirement.

In addition, a device for TSV modeling is provided, including: a memory, a processor, and a computer program stored on the memory and executable on the processor.

The processor, when executing the computer program, performs:
building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

In an embodiment, the first calculated parameter includes a resistance, an inductance, a capacitance, and a conductance of the cylindrical TSV model pair, where
the inductance of the cylindrical TSV model pair is calculated by: L_{C-TSV}=L_{in,C-TSV}+L_{ext,C-TSV}, L_{C-TSV} represents the inductance of the cylindrical TSV model pair, L_{in,C-TSV} represents an internal inductance of the cylindrical TSV body related with current distribution, and is expressed as:

$${L}_{i n , C - T S V} = \frac{{μ}_{0} {μ}_{C u} {h}_{C - T S V}}{8 π} ,$$

μ₀ representing a of vacuum and μ₀=4π×10⁻⁷ H/m, μ_{Cu} representing a permeability of copper, and h_{C-TSV} representing a height of the cylindrical TSV body, and L_{ext,C-TSV} represents an external inductance of the cylindrical TSV body unrelated with a frequency, and is expressed as: L_{ext,C-TSV}

$${L}_{e x t , C - T S V} = \frac{{μ}_{0} {μ}_{C u}}{2 π} [ {h}_{C - T S V} ln ( \frac{{h}_{C - TSV} + \sqrt{{h}_{C - T S V}^{2} + {r}_{C - T S V}^{2}}}{{r}_{C - TSV}} ) + {r}_{C - T S V} - \sqrt{{h}_{C - T S V}^{2} + {r}_{C - T S V}^{2}} ] ,$$

r_{C-TSV} representing a radius of the cylindrical TSV body.

In an embodiment, the second calculated parameter includes a resistance, an inductance, a capacitance, and a conductance of the tapered TSV model pair, and the capacitance of the tapered TSV model pair is calculated based on a capacitance of an isolation layer of the tapered TSV model pair, a capacitance of a substrate of the tapered TSV model pair, and an equivalent circuit diagram of the tapered TSV model pair, where
the resistance of the tapered TSV model pair is calculated by:

$${R}_{T - T S V} = \sqrt{{R}_{a c , T - T S V}^{2} + {R}_{d c , T - T S V}^{2}} ,$$

R_{T-TSV} represents the resistance of the tapered TSV model pair, R_{ac,T-TSV} represents a high-frequency alternating-current resistance of the tapered TSV model pair and is expressed as:

$${R}_{a c , T - T S V} = \frac{{ρ}_{C u} ( 2 + {β}^{2} )}{4 πβδ} ln [ 1 + \frac{2 {h}_{T - T S V} β}{( 2 {r}_{a} - δ )} ] ,$$

ρ_{Cu} representing a resistivity of copper, β=tan θ_{T-TSV}, θ_{T-TSV} representing a taper inclination angle of the tapered TSV body, δ representing a skin depth,

$$δ = \sqrt{\frac{{ρ}_{Cu}}{π f {μ}_{0} {μ}_{C u}}} ,$$

f representing an operating frequency of the tapered TSV body, rₐ representing a radius of a bottom of the tapered TSV body, rₐ=r_{T-TSV}−βh_{T-TSV}, r_{T-TSV} representing a radius of a top of the tapered TSV body, and h_{T-TSV} representing a height of the tapered TSV body, and R_{dc,T-TSV} represents a low-frequency direct-current resistance of the tapered TSV model pair and is expressed as:

$${R}_{d c , T - T S V} = \frac{{ρ}_{C u} {h}_{T - T S V} ( 1 + 0.5 \times {β}^{2} )}{π {r}_{a} ( {r}_{a} + β {h}_{T - TSV} )} ;$$

in a case that β is less than 0.1, the inductance of the tapered TSV model pair is calculated by: L_{T-TSV}=L_{in,T-TSV}+L_{ext,T-TSV}, L_{T-TSV} represents the inductance of the tapered TSV model pair, L_{in,T-TSV} represents an internal inductance of the tapered TSV model pair and is expressed as:

$${L}_{i n , T - T S V} = \frac{{μ}_{0} {μ}_{C u}}{2 π} [ \frac{{h}_{T - T S V}}{4} + {h}_{T - T S V} ln \frac{\sqrt{{h}_{T - TSV}^{2} + {r}_{a}^{2} + {h}_{T - TSV}}}{{r}_{a}} + {r}_{a} - \sqrt{{h}_{T - TSV}^{2} + {r}_{a}^{2}} + \frac{2 {h}_{T - TSV} β ( {h}_{T - TSV}^{2} - ( {h}_{T - TSV} + {r}_{a} ) ( \sqrt{{h}_{T - TSV}^{2} + {r}_{a}^{2}} - {r}_{a} ) )}{( \sqrt{{h}_{T - TSV}^{2} + {r}_{a}^{2}} - {r}_{a} ) ( 4 {r}_{a} + {h}_{T - TSV} β )} ] ,$$

and L_{ext,T-TSV} represents an external inductance of the tapered TSV model pair and is expressed as:

$${L}_{e x t , T - T S V} = \frac{{μ}_{0} {μ}_{C u}}{2 π} [ {h}_{T - T S V} ln \frac{\sqrt{{h}_{T - TSV}^{2} + {p}_{T - TSV}^{2} + {h}_{T - TSV}}}{{p}_{T - TSV}} + {p}_{T - TSV} - \sqrt{{h}_{T - TSV}^{2} + {p}_{T - TSV}^{2}} + \frac{2 {h}_{T - TSV} β ( {h}_{T - TSV}^{2} - ( {h}_{T - TSV} + {p}_{T - TSV} ) ( \sqrt{{h}_{T - TSV}^{2} + {p}_{T - TSV}^{2}} - {p}_{T - TSV} ) )}{( \sqrt{{h}_{T - TSV}^{2} + {p}_{T - TSV}^{2}} - {p}_{T - TSV} ) ( 4 {p}_{T - TSV} + {h}_{T - TSV} β )} ] ,$$

p_{T-TSV} representing a distance between tapered TSV bodies of the two tapered TSV models in the tapered TSV model pair;
the capacitance of the isolation layer of the tapered TSV model pair is calculated by:

$${C}_{o x , T - TSV} = 2 {πε}_{0} {ε}_{S i {O}_{2}} \times \{ \frac{{h}_{T - TSV}}{ln ( \frac{{r}_{a} + {t}_{o x}}{{r}_{a}} )} + \frac{β {t}_{o x} {h}_{T - TSV}^{2}}{2 {{r}_{a} ( {r}_{a} + {t}_{ox} ) [ ln ( \frac{{r}_{a} + {t}_{o x}}{{r}_{a}} ) ]}^{2}} \} ,$$

ε₀ representing a permittivity of vacuum, ε_{SiO}_{₂} representing a relative permittivity of silicon dioxide, tₒₓ representing a thickness of the isolation layer of silicon dioxide, and tₒₓ=0.1 micrometer; and
the capacitance of the substrate of the tapered TSV model pair is calculated by:

$${C}_{S i , T - T S V} = 2 {πε}_{0} {ε}_{Si} \times \{ \frac{{h}_{T - TSV}}{{cosh}^{- 1} ( \frac{{p}_{T - TSV}^{2}}{2 {( {r}_{a} + {t}_{ox} )}^{2}} - 1 )} - \frac{β {h}_{T - TSV}^{2} {p}_{T - TSV} ( \frac{2 {( {r}_{a} + {t}_{ox} )}^{2} - {p}_{T - TSV}^{2}}{\sqrt{{p}_{T - TSV}^{2} - 4 {( {r}_{a} + {t}_{ox} )}^{2}}} - {p}_{T - TSV} )}{\begin{matrix}4 {{r}_{a}^{3} [ {cosh}^{- 1} ( \frac{{p}_{T - TSV}^{2}}{2 {( {r}_{a} + {t}_{ox} )}^{2}} - 1 ) ]}^{2} \\ [ \frac{{p}_{T - TSV}^{2}}{2 {( {r}_{a} + {t}_{ox} )}^{2}} - 1 + \sqrt{{( \frac{{p}_{T - TSV}^{2}}{2 {( {r}_{a} + {t}_{ox} )}^{2}} - 1 )}^{2} - 1} ]\end{matrix}} \} ,$$

ε_{Si} representing a relative permittivity of silicon.

In an embodiment, the third calculated parameter includes a resistance, an inductance, a capacitance, and a conductance of the reentrant TSV model pair, and the capacitance of the reentrant TSV model pair is calculated based on a capacitance of an isolation layer of the reentrant TSV model pair, a capacitance of a substrate of the reentrant TSV model pair, and an equivalent circuit diagram of the reentrant TSV model pair, where
the resistance of the reentrant TSV model pair is calculated by:

$${R}_{R - T S V} = \sqrt{{R}_{a c , R - T S V}^{2} + {R}_{d c , R - T S V}^{2}} ,$$

R_{R-TSV} represents the resistance of the reentrant TSV model pair, R_{ac,R-T}SV represents a high-frequency alternating-current resistance of the reentrant TSV model pair and is expressed as:

$${R}_{a c , R - T S V} = \frac{{ρ}_{C u} ( 2 + {α}^{2} )}{4 παδ} ln [ 1 + \frac{2 {c}_{1} {h}_{R - T S V} α}{( 2 {r}_{b} - δ )} ] + \frac{{ρ}_{Cu} {c}_{2} {h}_{R - TSV}}{π [ {r}_{b}^{2} - {( {r}_{b} - δ )}^{2} ]} ,$$

c₁ and c₂ representing a ratio of a height of a cylindrical part in the reentrant TSV body to a height of the reentrant TSV body and a ratio of a height of a tapered part in the reentrant TSV body to the height of the reentrant TSV body, respectively, α=tan θ_{R-TSV}, θ_{R-TSV} representing a taper inclination angle of the tapered part in the reentrant TSV body, h_{R-TSV} representing the height of the reentrant TSV body, r_{b} representing a radius of the cylindrical part in the reentrant TSV body, r_{b}=r_{R-TSV}−αc₂h_{R-TSV}, and r_{R-TSV} representing a radius of a top of the tapered part in the reentrant TSV body, and R_{dc,R-TSV} represents a low-frequency direct-current resistance of the reentrant TSV model pair and is expressed as:

$${R}_{d c , R - TSV} = \frac{{ρ}_{C u} {c}_{1} {h}_{R - TSV} ( 1 + 0 \text{.5} \times {α}^{2} )}{π {r}_{T - TSV} ( {r}_{b} + {c}_{1} α {h}_{R - TSV} )} + \frac{{ρ}_{C u} {c}_{2} {h}_{R - TSV}}{π {r}_{b}^{2}} ;$$

in a case that β is less than 0.1, the inductance of the reentrant TSV model pair is calculated by: L_{R-TSV}=L_{in,R-TSV}+L_{ext,R-TSV}, L_{R-TSV} represents the inductance of the reentrant TSV model pair, L_{in,R-TSV} represents an internal inductance of the reentrant TSV model pair and is expressed as:

$${L}_{in , R - TSV} = \frac{{μ}_{0} {μ}_{C u} {c}_{1} {h}_{R - TSV}}{8 π} + \frac{{μ}_{0} {μ}_{C u}}{2 π} [ \frac{{c}_{2} {h}_{R - TSV}}{4} + {h}_{T - TSV} ln \frac{\sqrt{{( {c}_{2} {h}_{R - TSV} )}^{2} + {r}^{2} b + {c}_{2} {h}_{R - TSV}}}{{r}_{a}} + {r}_{a} - \sqrt{{( {c}_{2} {h}_{R - TSV} )}^{2} + {r}_{b}^{2}} + \frac{\begin{matrix}2 {c}_{2} {h}_{R - TSV} β ( {( {c}_{2} {h}_{R - TSV} )}^{2} - \\ ( {c}_{2} {h}_{R - TSV} + {r}_{b} ) ( \sqrt{{( {c}_{2} {h}_{R - TSV} )}^{2} + {r}_{b}^{2}} - {r}_{b} ) )\end{matrix}}{( \sqrt{{( {c}_{2} {h}_{R - TSV} )}^{2} + {r}_{b}^{2}} - {r}_{b} ) ( 4 {r}_{b} + {c}_{2} {h}_{R - TSV} α )} ] ,$$

and L_{ext,R-TSV} represents an external inductance of the reentrant TSV model pair and is expressed as:

$${L}_{e x t , R - T S V} = \frac{{μ}_{0} {μ}_{C u}}{2 π} ( \frac{{c}_{1} {h}_{R - TSV} + \sqrt{{h}_{C - TSV}^{2} + {r}_{b}^{2}}}{{r}_{b}} ) + {r}_{b} - \sqrt{{( {c}_{1} {h}_{R - T S V} )}^{2} + {r}_{b}^{2}} + \frac{{μ}_{0} {μ}_{C u}}{2 π} [ {c}_{2} {h}_{R - T S V} ln \frac{\sqrt{{( {c}_{2} {h}_{R - T S V} )}^{2} + {p}_{R - T S V}^{2} + {c}_{2} {h}_{R - T S V}}}{{p}_{R - T S V}} + {p}_{R - T S V} - \sqrt{{( {c}_{2} {h}_{R - T S V} )}^{2} + {p}_{R - T S V}^{2}} + \frac{\begin{matrix}2 {c}_{2} {h}_{R - T S V} α ( {( {c}_{2} {h}_{R - T S V} )}^{2} - ( {c}_{2} {h}_{R - T S V} + {p}_{T - T S V} ) \\ ( \sqrt{{( {c}_{2} {h}_{R - T S V} )}^{2} + {p}_{R - T S V}^{2}} - {p}_{R - T S V} ) )\end{matrix}}{( \sqrt{{( {c}_{2} {h}_{R - T S V} )}^{2} + {p}_{R - T S V}^{2}} - {p}_{R - T S V} ) ( 4 {p}_{R - TSV} + {c}_{2} {h}_{R - T S V} α )} ] ,$$

p_{R-TSV} representing a distance between reentrant TSV bodies of the two reentrant TSV models in the reentrant TSV model pair;
the capacitance of the isolation layer of the reentrant TSV model pair is calculated by:

$${C}_{o x , T - TSV} = 2 {πε}_{0} {ε}_{S i {O}_{2}} \times \{ \frac{{c}_{2} {h}_{R - TSV}}{ln ( \frac{{r}_{b} + {t}_{o x}}{{r}_{b}} )} + \frac{α {{t}_{o x} ( {c}_{2} {h}_{R - TSV} )}^{2}}{2 {{r}_{b} ( {r}_{b} + {t}_{ox} ) [ ln ( \frac{{r}_{b} + {t}_{o x}}{{r}_{b}} ) ]}^{2}} \} + \frac{2 {πε}_{0} {ε}_{s i {o}_{2}} {c}_{1} {h}_{R - TSV}}{ln ( \frac{{r}_{b} + {t}_{o x}}{{r}_{b}} )} ;$$

and
the capacitance of the substrate of the reentrant TSV model pair is calculated by:

$${C}_{Si , T - TSV} = 2 {πε}_{0} {ε}_{Si} \times \{ \frac{{c}_{2} {h}_{R - TSV}}{{cosh}^{- 1} ( \frac{{p}_{R - TSV}^{2}}{2 {( {r}_{b} + {t}_{ox} )}^{2}} - 1 )} - \frac{{α ( {c}_{2} {h}_{R - TSV} )}^{2} {p}_{T - TSV} ( \frac{2 {( {r}_{b} + {t}_{ox} )}^{2} - {p}_{R - TSV}^{2}}{\sqrt{{p}_{R - TSV}^{2} - 4 {( {r}_{b} + {t}_{ox} )}^{2}}} - {p}_{R - TSV} )}{\begin{matrix}4 {{r}_{b}^{3} [ {cosh}^{- 1} ( \frac{{p}_{R - TSV}^{2}}{2 {( {r}_{b} + {t}_{ox} )}^{2}} - 1 ) ]}^{2} \\ [ \frac{{p}_{R - TSV}^{2}}{2 {( {r}_{b} + {t}_{ox} )}^{2}} - 1 + \sqrt{{( \frac{{p}_{R - TSV}^{2}}{2 {( {r}_{b} + {t}_{ox} )}^{2}} - 1 )}^{2} - 1 ]}\end{matrix}} \} + \frac{2 {πε}_{0} {ε}_{Si} {c}_{1} {h}_{R - TSV}}{ln ( \frac{{p}_{R - TSV}}{2 {r}_{b}} + \sqrt{{( \frac{{p}_{R - TSV}}{2 {r}_{b}} )}^{2} - 1 )}} .$$

In an embodiment, the fourth calculated parameter includes a transmission line characteristic parameter of the first ellipsoidal bump in the cylindrical TSV model pair, a transmission line characteristic parameter of the second ellipsoidal bump in the tapered TSV model pair, and a transmission line characteristic parameter of the third ellipsoidal bump in the reentrant TSV model pair, the transmission line characteristic parameter of the first ellipsoidal bump in the cylindrical TSV model pair includes a resistance, an inductance, a capacitance, and a conductance of the first ellipsoidal bump in the cylindrical TSV model pair, the transmission line characteristic parameter of the second ellipsoidal bump in the tapered TSV model pair includes a resistance, an inductance, a capacitance, and a conductance of the second ellipsoidal bump in the tapered TSV model pair, and the transmission line characteristic parameter of the third ellipsoidal bump in the reentrant TSV model pair includes a resistance, an inductance, a capacitance, and a conductance of the third ellipsoidal bump in the reentrant TSV model pair, where
for each of the first ellipsoidal bump in the cylindrical TSV model pair, the second ellipsoidal bump in the tapered TSV model pair, and the third ellipsoidal bump in the reentrant TSV model pair,
   a capacitance of the ellipsoidal bump is calculated by:

$${C}_{Bump} = \frac{1}{2} {C}_{Bump 1} ,$$

C_{Bump1} represents a half-capacitance of the ellipsoidal bump, and

$${C}_{B u m p 1} = {πε}_{0} {ε}_{underfill} \times \{ \frac{{h}_{Bump}}{{cosh}^{- 1} ( \frac{{p}_{T S V}^{2}}{2 {( {r}_{Bump} )}^{2}} - 1 )} \} ,$$

h_{Bump} representing a height of the ellipsoidal bump, r_{Bump} representing a radius of the ellipsoidal bump, p_{TSV} representing a distance between two TSV bodies in the corresponding TSV model pair, and ε_{underfill} representing a relative permittivity of an underfill.

In an embodiment, each of the first ellipsoidal bump in the cylindrical TSV model pair, the second ellipsoidal bump in the tapered TSV model pair, and the third ellipsoidal bump in the reentrant TSV model pair has a diameter of 25 micrometers, a radius of 12.5 micrometers, and a height of 18 micrometers.

In an embodiment, any one TSV body in the cylindrical TSV model pair, in the tapered TSV model pair, and in the reentrant TSV model pair is surrounded by an isolation layer, a material of the isolation layer is silicon dioxide, and a thickness of the isolation layer is 0.1 micrometer.

Furthermore, a computer-readable storage medium is further provided according to the embodiments of the present disclosure. The computer-readable storage medium stores instructions, and the instructions, when being executed on a terminal device, cause the terminal device to perform:
building a TSV model set, where the TSV model set includes a cylindrical TSV model pair, a tapered TSV model pair, and a reentrant TSV model pair, where
   the cylindrical TSV model pair includes two cylindrical TSV models with a same form, each of the two cylindrical TSV models including a cylindrical TSV body with a first end connected to a first ellipsoidal bump through a first pad, and a second end of the cylindrical TSV body being connected to a second pad,
   the tapered TSV model pair includes two tapered TSV models with a same form, each of the two tapered TSV models including a tapered TSV body with a first end connected to a second ellipsoidal bump through a third pad, and a second end of the tapered TSV body being connected to a fourth pad, and
   the reentrant TSV model pair includes two reentrant TSV models with a same form, each of the two reentrant TSV models including a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

The method, the device, and the apparatus for TSV modeling, and the storage medium are provided in the embodiments of the present disclosure. In the present disclosure, the conventional approach of simplifying an ellipsoidal bump into a cylindrical bump is avoided by employing the cylindrical, tapered, and reentrant TSV model pairs in combination with actual geometric features of the ellipsoidal bump, effectively enhancing modeling accuracy, and accurately reflecting a complex geometric form of an actual package. TSV models with different forms allow for accurate electrical performance of the ellipsoidal bumps in various packaging and interconnection structures. Especially in high-density interconnection or large-scale packaging, such TSV models with different forms help avoid electrical performance prediction errors caused by the simplification, thereby providing more accurate and reliable data support for packaging design.

A detailed description for the method, the device, and the apparatus for TSV modeling, and the storage medium therefor disclosed in the present disclosure has been provided above. The embodiments in the specification are described in a progressive manner. Each of the embodiments mainly focuses on differences from other embodiments, and references can be made to each other for the same or similar parts among the embodiments. Since the device disclosed in the embodiments corresponds to the method disclosed in the embodiments, the description for the device is simple, and reference may be made to the method in the embodiments for the relevant parts. It should be noted that, those skilled in the art may make several improvements and modifications to the present disclosure without departing from the principles of the present disclosure. These improvements and modifications shall fall within the protection scope of the claims of the present disclosure.

It should be understood that in the present disclosure, the term “at least one” refers to a quantity equal to one or more, and the term “multiple” refers to a quantity equal to two or more. The term “and/or” is used to describe an association relationship between associated objects, and indicates three possible relationships. For example, “A and/or B” may indicate a case in which only A exists, a case in which only B exists, or a case in which both A and B exist.

In the above cases, each of A and B may be singular or plural. The symbol “/” generally indicates that a former object and a latter object are associated by an “or” relationship. The term “at least one of following” or similar expressions refer to any combination of following items, including any combination of a single item or multiple items. For example, at least one of a, b, or c may indicate: a, b, c, “a and b”, “a and c”, “b and c”, or “a, b, and c”, where each of a, b, and c may be singular or plural.

It should be further noted that relation terms such as “first” and “second” herein are only used to distinguish one entity or operation from another entity or operation, and do not necessarily require or imply that there is an actual relation or sequence between these entities or operations. Furthermore, the term “comprise”, “include” or any other variation thereof is intended to cover a non-exclusive inclusion, so that a process, a method, an article, or a device including a set of elements includes not only those elements, but also other elements not expressly listed or elements inherent in such a process, method, article, or device. Unless expressively limited, the statement “including a . . . ” does not exclude the case that other similar elements may exist in the process, method, article or device including the series of elements.

1. A method for through-silicon via (TSV) modeling, comprising:
building a TSV model set, wherein the TSV model set comprises a cylindrical TSV model pair, a tapered TSV model pair, and a reentrant TSV model pair, wherein
the cylindrical TSV model pair comprises two cylindrical TSV models with a same form, each of the two cylindrical TSV models comprising a cylindrical TSV body with a first end connected to a first ellipsoidal bump through a first pad, and a second end of the cylindrical TSV body being connected to a second pad,
the tapered TSV model pair comprises two tapered TSV models with a same form, each of the two tapered TSV models comprising a tapered TSV body with a first end connected to a second ellipsoidal bump through a third pad, and a second end of the tapered TSV body being connected to a fourth pad, and
the reentrant TSV model pair comprises two reentrant TSV models with a same form, each of the two reentrant TSV models comprising a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

2. The method according to claim 1, wherein the first calculated parameter comprises a resistance, an inductance, a capacitance, and a conductance of the cylindrical TSV model pair, wherein
the inductance of the cylindrical TSV model pair is calculated by: L_{C-TSV}=L_{in,C-TSV}+L_{ext,C-TSV}, L_{C-TSV} represents the inductance of the cylindrical TSV model pair, L_{in,C-TSV} represents an internal inductance of the cylindrical TSV body related with current distribution, and is expressed as:
$${L}_{i n , C - TSV} = \frac{{μ}_{0} {μ}_{C u} {h}_{C - TSV}}{8 π} ,$$
μ₀ representing a permeability of vacuum and μ₀=4π×10⁻⁷H/m, μ_{Cu} representing a permeability of copper, and h_{C-TSV} representing a height of the cylindrical TSV body, and L_{ext,C-TSV} represents an external inductance of the cylindrical TSV body unrelated with a frequency, and is expressed as:
$${L}_{e x t , C - TSV} = \frac{{μ}_{0} {μ}_{C u}}{2 π} [ {h}_{C - TSV} ln ( \frac{{h}_{C - TSV} + \sqrt{{h}_{C - TSV}^{2} + {r}_{C - TSV}^{2}}}{{r}_{C - TSV}} ) + {r}_{C - T S V} - \sqrt{{h}_{C - TSV}^{2} + {r}_{C - TSV}^{2}} ] ,$$
r_{C-TSV} representing a radius of the cylindrical TSV body.

3. The method according to claim 2, wherein the second calculated parameter comprises a resistance, an inductance, a capacitance, and a conductance of the tapered TSV model pair, and the capacitance of the tapered TSV model pair is calculated based on a capacitance of an isolation layer of the tapered TSV model pair, a capacitance of a substrate of the tapered TSV model pair, and an equivalent circuit diagram of the tapered TSV model pair, wherein
the resistance of the tapered TSV model pair is calculated by:
$${R}_{T - T S V} = \sqrt{{R}_{ac , T - T S V}^{2} + {R}_{dc , T - T S V}^{2}} ,$$
R_{T-TSV} represents the resistance of the tapered TSV model pair, R_{ac,T-TSV} represents a high-frequency alternating-current resistance of the tapered TSV model pair and is expressed as:
$${R}_{a c , T - TSV} = \frac{{ρ}_{C u} ( 2 + {β}^{2} )}{4 πβδ} ln [ 1 + \frac{2 {h}_{T - TSV} β}{( 2 {r}_{a} - δ )} ] ,$$
ρ_{Cu} representing a resistivity of copper, β=tan θ_{T-TSV}, θ_{T-TSV} representing a taper inclination angle of the tapered TSV body, δ representing a skin depth,
$$δ = \sqrt{\frac{{ρ}_{Cu}}{π f {μ}_{0} {μ}_{C u}}} ,$$
f representing an operating frequency of the tapered TSV body, rₐ representing a radius of a bottom of the tapered TSV body, rₐ=r_{T-TSV}−βh_{T-TSV}, r_{T-TSV} representing a radius of a top of the tapered TSV body, and h_{T}-TSV representing a height of the tapered TSV body, and R_{dc,T-TSV} represents a low-frequency direct-current resistance of the tapered TSV model pair and is expressed as:
$${R}_{d c , T - TSV} = \frac{{ρ}_{C u} {h}_{T - TSV} ( 1 + 0. 5 \times {β}^{2} )}{π {r}_{a} ( {r}_{a} + β {h}_{T - TSV} )} ;$$
in a case that β is less than 0.1, the inductance of the tapered TSV model pair is calculated by: L_{T-TSV}=L_{in,T-TSV}+L_{ext,T-TSV}, L_{T-TSV} represents the inductance of the tapered TSV model pair, L_{in,T-TSV} represents an internal inductance of the tapered TSV model pair and is expressed as:
$${L}_{i n , T - TSV} = \frac{{μ}_{0} {μ}_{C u}}{2 π} [ \frac{{h}_{T - TSV}}{4} + {h}_{T - TSV} ln \frac{\sqrt{{h}_{T - TSV}^{2} + {r}_{a}^{2} + {h}_{T - TSV}}}{{r}_{a}} + {r}_{a} - \sqrt{{h}_{T - T S V}^{2} + {r}_{a}^{2}} + \frac{2 {h}_{T - T S V} β ( {h}_{T - TSV}^{2} - ( {h}_{T - TSV} + {r}_{a} ) ( \sqrt{{h}_{T - TSV}^{2} + {r}_{a}^{2}} - {r}_{a} ) )}{( \sqrt{{h}_{T - TSV}^{2} + {r}_{a}^{2}} - {r}_{a} ) ( 4 {r}_{a} + {h}_{T - TSV} β )} ] ,$$
and L_{ext,T-TSV} represents an external inductance of the tapered TSV model pair and is expressed as:
$${L}_{e x t , T - T S V} = \frac{{μ}_{0} {μ}_{C u}}{2 π} [ {h}_{T - TSV} ln \frac{\sqrt{{h}_{T - TSV}^{2} + {P}_{T - TSV}^{2} + {h}_{T - TSV}}}{{p}_{T - TSV}} + {p}_{T - TSV} - \sqrt{{h}_{T - TSV}^{2} + {p}_{T - TSV}^{2}} + \frac{\begin{matrix}2 {h}_{T - TSV} β ( {h}_{T - TSV}^{2} - ( {h}_{T - TSV} + {p}_{T - TSV} ) \\ ( \sqrt{{h}_{T - TSV}^{2} + {p}_{T - TSV}^{2}} - {p}_{T - TSV} ) )\end{matrix}}{( \sqrt{{h}_{T - TSV}^{2} + {p}_{T - TSV}^{2}} - {p}_{T - TSV} ) ( 4 {p}_{T - TSV} + {h}_{T - TSV} β )} ] ,$$
p_{T-TSV} representing a distance between tapered TSV bodies of the two tapered TSV models in the tapered TSV model pair;
the capacitance of the isolation layer of the tapered TSV model pair is calculated by:
$${C}_{o x , T - TSV} = 2 {πε}_{0} {ε}_{S i {O}_{2}} \times \{ \frac{{h}_{T - TSV}}{ln ( \frac{{r}_{a} + {t}_{o x}}{{r}_{a}} )} + \frac{β {t}_{o x} {h}_{T - TSV}^{2}}{2 {{r}_{a} ( {r}_{a} + {t}_{ox} ) [ ln ( \frac{{r}_{a} + {t}_{o x}}{{r}_{a}} ) ]}^{2}} \} ,$$
ε₀ representing a permittivity of vacuum, ε_{SiO}_{₂} representing a relative permittivity of silicon dioxide, tₒₓ representing a thickness of the isolation layer of silicon dioxide, and tₒₓ=0.1 micrometer; and
the capacitance of the substrate of the tapered TSV model pair is calculated by:
$${c}_{Si , T - TSV} = 2 {πε}_{0} {ε}_{Si} \times \{ \frac{{h}_{T - TSV}}{{cosh}^{- 1} ( \frac{{p}_{T - TSV}^{2}}{2 {( {r}_{a} + {t}_{ox} )}^{2}} - 1 )} - \frac{β {h}_{T - TSV}^{2} {p}_{T - TSV} ( \frac{2 {( {r}_{a} + {t}_{ox} )}^{2} - {p}_{T - TSV}^{2}}{\sqrt{{p}_{T - TSV}^{2} - 4 {( {r}_{a} + {t}_{ox} )}^{2}}} - {P}_{T - TSV} )}{\begin{matrix}4 {{r}_{a}^{3} [ {cosh}^{- 1} ( \frac{{p}_{T - TSV}^{2}}{2 {( {r}_{a} + {t}_{ox} )}^{2}} - 1 ) ]}^{2} \\ [ \frac{{p}_{T - TSV}^{2}}{2 {( {r}_{a} + {t}_{ox} )}^{2}} - 1 + \sqrt{{( \frac{{p}_{T - TSV}^{2}}{2 {( {r}_{a} + {t}_{ox} )}^{2}} - 1 )}^{2} - 1 ]}\end{matrix}} \} ,$$
ε_{Si} representing a relative permittivity of silicon.

4. The method according to claim 3, wherein the third calculated parameter comprises a resistance, an inductance, a capacitance, and a conductance of the reentrant TSV model pair, and the capacitance of the reentrant TSV model pair is calculated based on a capacitance of an isolation layer of the reentrant TSV model pair, a capacitance of a substrate of the reentrant TSV model pair, and an equivalent circuit diagram of the reentrant TSV model pair, wherein
the resistance of the reentrant TSV model pair is calculated by:
$${R}_{R - T S V} = \sqrt{{R}_{ac , R - T S V}^{2} + {R}_{dc , R - T S V}^{2}} ,$$
R_{R-TSV} represents the resistance of the reentrant TSV model pair, R_{ac,R-TSV} represents a high-frequency alternating-current resistance of the reentrant TSV model pair and is expressed as:
$${R}_{a c , R - TSV} = \frac{{p}_{C u} ( 2 + {α}^{2} )}{4 παδ} ln [ 1 + \frac{2 {c}_{1} {h}_{R - TSV} α}{( 2 {r}_{b} - δ )} ] + \frac{{ρ}_{Cu} {c}_{2} {h}_{R - TSV}}{π [ {r}_{b}^{2} - {( {r}_{b} - δ )}^{2} ]} ,$$
c₁ and c₂ representing a ratio of a height of a cylindrical part in the reentrant TSV body to a height of the reentrant TSV body and a ratio of a height of a tapered part in the reentrant TSV body to the height of the reentrant TSV body, respectively, α=tan θ_{R-TSV}, θ_{R-TSV} representing a taper inclination angle of the tapered part in the reentrant TSV body, h_{R-TSV} representing the height of the reentrant TSV body, r_{b} representing a radius of the cylindrical part in the reentrant TSV body, r_{b}=r_{R-TSV}−αc₂h_{R-TSV}, and r_{R-TSV} representing a radius of a top of the tapered part in the reentrant TSV body, and R_{dc,R-TSV} represents a low-frequency direct-current resistance of the reentrant TSV model pair and is expressed as:
$${R}_{d c , R - TSV} = \frac{{ρ}_{C u} {c}_{1} {h}_{R - TSV} ( 1 + 0 \text{.5} \times {α}^{2} )}{π {r}_{T - TSV ( {r}_{b} + {c}_{1} α {h}_{R - T S V} )}} + \frac{{ρ}_{C u} {c}_{2} {h}_{R - TSV}}{π {r}_{b}^{2}} ;$$
in a case that β is less than 0.1, the inductance of the reentrant TSV model pair is calculated by: L_{R-TS}V L_{in,R-TSV}+L_{ext,R-TSV}, L_{R-TSV} represents the inductance of the reentrant TSV model pair, L_{in,R-TSV} represents an internal inductance of the reentrant TSV model pair and is expressed as:
$${L}_{in , R - TSV} = \frac{{μ}_{0} {μ}_{C u} {c}_{1} {h}_{R - T S V}}{8 π} + \frac{{μ}_{0} {μ}_{C u}}{2 π} [ \frac{{c}_{2} {h}_{T - TSV}}{4} + {h}_{T - TSV} ln \sqrt{\frac{{( {c}_{2} {h}_{R - T S V} )}^{2} + {r}_{b}^{2} + {c}_{2} {h}_{R - TSV}}{{r}_{a}}} + {r}_{a} - \sqrt{{( {c}_{2} {h}_{R - TSV} )}^{2} + {r}_{b}^{2}} ] + \frac{\begin{matrix}2 {c}_{2} {h}_{R - T S V} β ( {( {c}_{2} {h}_{R - T S V} )}^{2} - ( {c}_{2} {h}_{R - TSV} + {r}_{b} ) \\ ( \sqrt{{( {c}_{2} {h}_{R - T S V} )}^{2} + {r}_{b}^{2}} - {r}_{b} ) )\end{matrix}}{( \sqrt{{( {c}_{2} {h}_{R - T S V} )}^{2} + {r}_{b}^{2}} - {r}_{b} ) ( 4 {r}_{b} + {c}_{2} {h}_{R - T S V} α )} ] ,$$
and L_{ext,R-TSV} represents an external inductance of the reentrant TSV model pair and is expressed as:
$${L}_{e x t , R - TSV} = \frac{{μ}_{0} {μ}_{C u}}{2 π} [ {c}_{1} {h}_{R - TSV} ln ( \frac{{c}_{1} {h}_{R - TSV} + \sqrt{{h}_{C - TSV}^{2} {r}_{b}^{2}}}{{r}_{b}} ) + {r}_{b} - \sqrt{{( {c}_{1} {h}_{R - TSV} )}^{2} + {r}_{b}^{2}} ] + \frac{{μ}_{0} {μ}_{C u}}{2 π} [ {c}_{2} {h}_{R - TSV} ln \frac{\sqrt{{( {c}_{2} {h}_{R - TSV} )}^{2} + {p}_{R - TSV}^{2} + {c}_{2} {h}_{R - TSV}}}{{p}_{R - TSV}} + {p}_{R - TSV} - \sqrt{{( {c}_{2} {h}_{R - TSV} )}^{2} + {p}_{R - TSV}^{2}} + \frac{\begin{matrix}2 {c}_{2} {h}_{R - TSV} α ( {( {c}_{2} {h}_{R - TSV} )}^{2} - ( {c}_{2} {h}_{R - TSV + PT - TSV} ) \\ ( \sqrt{{( {c}_{2} {h}_{R - TSV} )}^{2} + {p}_{R - TSV}^{2}} - {p}_{R - TSV} ) )\end{matrix}}{( \sqrt{{( {c}_{2} {h}_{R - TSV} )}^{2} + {p}_{R - TSV}^{2}} - {p}_{R - TSV} ) ( 4 {p}_{R - TSV} + {c}_{2} {h}_{R - TSV} α )} ] ,$$
p_{R-TSV} representing a distance between reentrant TSV bodies of the two reentrant TSV models in the reentrant TSV model pair;
the capacitance of the isolation layer of the reentrant TSV model pair is calculated by:
$${C}_{o x , R - TSV} = 2 {πε}_{0} {ε}_{S i {O}_{2}} \times \{ \frac{{c}_{2} {h}_{R - TSV}}{ln ( \frac{{r}_{b} + {t}_{o x}}{{r}_{b}} )} + \frac{α {{t}_{o x} ( {c}_{2} {h}_{R - TSV} )}^{2}}{2 {{r}_{b} ( {r}_{b} + {t}_{ox} ) [ ln ( \frac{{r}_{b} + {t}_{o x}}{{r}_{b}} ) ]}^{2}} \} + \frac{2 {πε}_{0} {ε}_{{SiO}_{2}} {c}_{1} {h}_{R - TSV}}{ln ( \frac{{r}_{b} + {t}_{o x}}{{r}_{b}} )} ;$$
and
the capacitance of the substrate of the reentrant TSV model pair is calculated by:
$${C}_{Si , R - TSV} = 2 {πε}_{0} {ε}_{Si} \times \{ \frac{{c}_{2} {h}_{R - T S V}}{{cosh}^{- 1} ( \frac{{p}_{R - T S V}^{2}}{2 {( {r}_{b} + {t}_{ox} )}^{2}} - 1 )} - \frac{{α ( {c}_{2} {h}_{R - TSV} )}^{2} {p}_{T - TSV} ( \frac{2 {( {r}_{b} + {t}_{ox} )}^{2} - {p}_{R - T S V}^{2}}{\sqrt{{p}_{R - T S V}^{2} - 4 {( {r}_{b} + {t}_{ox} )}^{2}}} - {p}_{R - TSV} )}{\begin{matrix}4 {{r}_{b}^{3} [ {cosh}^{- 1} ( \frac{{p}_{R - T S V}^{2}}{2 {( {r}_{b} + {t}_{ox} )}^{2}} - 1 ) ]}^{2} \\ [ \frac{{p}_{R - T S V}^{2}}{2 {( {r}_{b} + {t}_{ox} )}^{2}} - 1 + \sqrt{{( \frac{{p}_{R - T S V}^{2}}{2 {( {r}_{b} + {t}_{ox} )}^{2}} - 1 )}^{2} - 1} ]\end{matrix}} \} + \frac{2 {πε}_{0} {ε}_{Si} {c}_{1} {h}_{R - TSV}}{ln ( \frac{{p}_{R - TSV}}{2 {r}_{b}} ) + \sqrt{{( \frac{{p}_{R - TSV}}{2 {r}_{b}} )}^{2} - 1 )}} .$$

5. The method according to claim 4, wherein the fourth calculated parameter comprises a transmission line characteristic parameter of the first ellipsoidal bump in the cylindrical TSV model pair, a transmission line characteristic parameter of the second ellipsoidal bump in the tapered TSV model pair, and a transmission line characteristic parameter of the third ellipsoidal bump in the reentrant TSV model pair, the transmission line characteristic parameter of the first ellipsoidal bump in the cylindrical TSV model pair comprises a resistance, an inductance, a capacitance, and a conductance of the first ellipsoidal bump in the cylindrical TSV model pair, the transmission line characteristic parameter of the second ellipsoidal bump in the tapered TSV model pair comprises a resistance, an inductance, a capacitance, and a conductance of the second ellipsoidal bump in the tapered TSV model pair, and the transmission line characteristic parameter of the third ellipsoidal bump in the reentrant TSV model pair comprises a resistance, an inductance, a capacitance, and a conductance of the third ellipsoidal bump in the reentrant TSV model pair, wherein
for each of the first ellipsoidal bump in the cylindrical TSV model pair, the second ellipsoidal bump in the tapered TSV model pair, and the third ellipsoidal bump in the reentrant TSV model pair,
a capacitance of the ellipsoidal bump is calculated by:
$${C}_{B u m p} = \frac{1}{2} {C}_{B ump 1} ,$$
C_{Bump1} represents a half-capacitance of the ellipsoidal bump, and
$${C}_{B u m p 1} = {πε}_{0} {ε}_{undefill} \times \{ \frac{{h}_{B u m p}}{{cosh}^{- 1} ( \frac{{p}_{T S V}^{2}}{2 {( {r}_{B u m p} )}^{2}} - 1 )} \} ,$$
h_{Bump} representing a height of the ellipsoidal bump, r_{Bump} representing a radius of the ellipsoidal bump, p_{TSV} representing a distance between two TSV bodies in the corresponding TSV model pair, and ε_{underfill} representing a relative permittivity of an underfill.

6. The method according to claim 1, wherein each of the first ellipsoidal bump in the cylindrical TSV model pair, the second ellipsoidal bump in the tapered TSV model pair, and the third ellipsoidal bump in the reentrant TSV model pair has a diameter of 25 micrometers, a radius of 12.5 micrometers, and a height of 18 micrometers.

7. The method according to claim 1, wherein any one TSV body in the cylindrical TSV model pair, in the tapered TSV model pair, and in the reentrant TSV model pair is surrounded by an isolation layer, a material of the isolation layer is silicon dioxide, and a thickness of the isolation layer is 0.1 micrometer.

8. A device for through-silicon via (TSV) modeling, comprising: a memory, a processor, and a computer program stored on the memory and executable on the processor, wherein the processor, when executing the computer program, performs:
building a TSV model set, wherein the TSV model set comprises a cylindrical TSV model pair, a tapered TSV model pair, and a reentrant TSV model pair, wherein
the cylindrical TSV model pair comprises two cylindrical TSV models with a same form, each of the two cylindrical TSV models comprising a cylindrical TSV body with a first end connected to a first ellipsoidal bump through a first pad, and a second end of the cylindrical TSV body being connected to a second pad,
the tapered TSV model pair comprises two tapered TSV models with a same form, each of the two tapered TSV models comprising a tapered TSV body with a first end connected to a second ellipsoidal bump through a third pad, and a second end of the tapered TSV body being connected to a fourth pad, and
the reentrant TSV model pair comprises two reentrant TSV models with a same form, each of the two reentrant TSV models comprising a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.

9. The device according to claim 8, wherein the first calculated parameter comprises a resistance, an inductance, a capacitance, and a conductance of the cylindrical TSV model pair, wherein
the inductance of the cylindrical TSV model pair is calculated by: L_{C-TSV}=L_{in,C-TSV}+L_{ext,C-TSV}, L_{C-TSV} represents the inductance of the cylindrical TSV model pair, L_{in,C-TSV} represents an internal inductance of the cylindrical TSV body related with current distribution, and is expressed as:
$${L}_{i n , C - TSV} = \frac{{μ}_{0} {μ}_{C u} {h}_{C - TSV}}{8 π} ,$$
μ₀ representing a permeability of vacuum and μ₀=4π×10⁻⁷ H/m, μ_{Cu} representing a permeability of copper, and h_{C-TSV} representing a height of the cylindrical TSV body, and L_{ext,C-TSV} represents an external inductance of the cylindrical TSV body unrelated with a frequency, and is expressed as:
$${L}_{e x t , C - TSV} = \frac{{μ}_{0} {μ}_{C u}}{2 π} [ {h}_{C - TSV} ln ( \frac{{h}_{C - TSV} + \sqrt{{h}_{C - TSV}^{2} + {r}_{C - TSV}^{2}}}{{r}_{C - TS V}} ) + {r}_{C - TSV} - \sqrt{{h}_{C - TSV}^{2} + {r}_{C - TSV}^{2}} ] ,$$
r_{C-TSV} representing a radius of the cylindrical TSV body.

10. The device according to claim 9, wherein the second calculated parameter comprises a resistance, an inductance, a capacitance, and a conductance of the tapered TSV model pair, and the capacitance of the tapered TSV model pair is calculated based on a capacitance of an isolation layer of the tapered TSV model pair, a capacitance of a substrate of the tapered TSV model pair, and an equivalent circuit diagram of the tapered TSV model pair, wherein the resistance of the tapered TSV model pair is calculated by:
$${R}_{T - T S V} = \sqrt{{R}_{ac , T - TSV}^{2} + {R}_{dc , T - TSV}^{2}} ,$$
R_{T-TSV} represents the resistance of the tapered TSV model pair, R_{ac,T-TSV} represents a high-frequency alternating-current resistance of the tapered TSV model pair and is expressed as:
$${R}_{a c , T - TSV} = \frac{{p}_{C u} ( 2 + {β}^{2} )}{4 πβδ} ln [ 1 + \frac{2 {h}_{T - TSV} β}{( 2 {r}_{a} - δ )} ] ,$$
ρ_{Cu} representing a resistivity of copper, β=tan θ_{T-TSV}, θ_{T-TSV} representing a taper inclination angle of the tapered TSV body, δ representing a skin depth,
$$δ = \sqrt{\frac{{ρ}_{Cu}}{π f {μ}_{0} {μ}_{C u}}} ,$$
f representing an operating frequency of the tapered TSV body, rₐ representing a radius of a bottom of the tapered TSV body, rₐ=r_{T-TSV}−βh_{T-TSV}, r_{T-TSV} representing a radius of a top of the tapered TSV body, and h_{T-TSV} representing a height of the tapered TSV body, and R_{dc,T-TSV} represents a low-frequency direct-current resistance of the tapered TSV model pair and is expressed as:
$${R}_{d c , T - T S V} = \frac{{ρ}_{C u} {h}_{T - T S V} ( 1 + 0.5 \times {β}^{2} )}{π {r}_{a} ( {r}_{a} + β {h}_{T - TSV} )} ;$$
in a case that β is less than 0.1, the inductance of the tapered TSV model pair is calculated by: L_{T-TSV} L_{in,T-TSV}+L_{ext,T-TSV}, L_{T-TSV} represents the inductance of the tapered TSV model pair, L_{in,T-TSV} represents an internal inductance of the tapered TSV model pair and is expressed as:
$${L}_{i n , T - T S V} = \frac{{μ}_{0} {μ}_{C u}}{2 π} [ \frac{{h}_{T - T S V}}{4} + {h}_{T - T S V} ln \frac{\sqrt{{h}_{T - TSV}^{2} + {r}_{a}^{2} + {h}_{T - TSV}}}{{r}_{a}} + {r}_{a} - \sqrt{{h}_{T - TSV}^{2} + {r}_{a}^{2}} + \frac{2 {h}_{T - TSV} β ( \begin{matrix}{h}_{T - TSV}^{2} - ( {h}_{T - TSV} + {r}_{a} ) \\ ( \sqrt{{h}_{T - TSV}^{2} + {r}_{a}^{2}} - {r}_{a} )\end{matrix} )}{( \sqrt{{h}_{T - TSV}^{2} + {r}_{a}^{2}} - {r}_{a} ) ( 4 {r}_{a} + {h}_{T - TSV} β )} ] ,$$
and L_{ext,T-TSV} represents an external inductance of the tapered TSV model pair and is expressed as:
$${L}_{ext , T - TSV} = \frac{{μ}_{0} {μ}_{C u}}{2 π} [ {h}_{T - TSV} ln \frac{\sqrt{{h}_{T - TSV}^{2} + {p}_{T - TSV}^{2} + {h}_{T - TSV}}}{{p}_{T - TSV}} + {p}_{T - TSV} - \sqrt{{h}_{T - TSV}^{2} + {p}_{T - TSV}^{2}} + \frac{2 {h}_{T - TSV} β ( \begin{matrix}{h}_{T - TSV}^{2} - ( {h}_{T - TSV} + {p}_{T - TSV} ) \\ ( \sqrt{{h}_{T - TSV}^{2} + {p}_{T - TSV}^{2}} - {p}_{T - TSV} )\end{matrix} )}{( \sqrt{{h}_{T - TSV}^{2} + {p}_{T - TSV}^{2}} - {p}_{T - TSV} ) ( 4 {p}_{T - TSV} + {h}_{T - TSV} β )} ] ,$$
p_{T-TSV} representing a distance between tapered TSV bodies of the two tapered TSV models in the tapered TSV model pair;
the capacitance of the isolation layer of the tapered TSV model pair is calculated by:
$${C}_{o x , T - TSV} = 2 {πε}_{0} {ε}_{S i {O}_{2}} \times \{ \frac{{h}_{T - TSV}}{ln ( \frac{{r}_{a} + {t}_{o x}}{{r}_{a}} )} + \frac{β {t}_{o x} {h}_{T - TSV}^{2}}{2 {{r}_{a} ( {r}_{a} + {t}_{ox} ) [ ln ( \frac{{r}_{a} + {t}_{o x}}{{r}_{a}} ) ]}^{2}} \} ,$$
ε₀ representing a permittivity of vacuum, ε_{SiO}_{₂} representing a relative permittivity of silicon dioxide, tₒₓ representing a thickness of the isolation layer of silicon dioxide, and tₒₓ=0.1 micrometer; and
the capacitance of the substrate of the tapered TSV model pair is calculated by:
$${C}_{Si , T - TSV} = 2 {πε}_{0} {ε}_{Si} \times \{ \frac{{h}_{T - TSV}}{{cosh}^{- 1} ( \frac{{p}_{T - TSV}^{2}}{2 {( {r}_{a} + {t}_{ox} )}^{2}} - 1 )} - \frac{β {h}_{T - TSV}^{2} {p}_{T - TSV} ( \frac{2 {( {r}_{a} + {t}_{ox} )}^{2} - {p}_{T - TSV}^{2}}{\sqrt{{p}_{T - TSV}^{2} - 4 {( {r}_{a} + {t}_{ox} )}^{2}}} - {p}_{T - TSV} )}{\begin{matrix}4 {{r}_{a}^{3} [ {cosh}^{- 1} ( \frac{{p}_{T - TSV}^{2}}{2 {( {r}_{a} + {t}_{ox} )}^{2}} - 1 ) ]}^{2} \\ [ \frac{{p}_{T - TSV}^{2}}{2 {( {r}_{a} + {t}_{ox} )}^{2}} - 1 + \sqrt{{( \frac{{p}_{T - TSV}^{2}}{2 {( {r}_{a} + {t}_{ox} )}^{2}} - 1 )}^{2} - 1} ]\end{matrix}} \} ,$$
ε_{Si} representing a relative permittivity of silicon.

11. The device according to claim 10, wherein the third calculated parameter comprises a resistance, an inductance, a capacitance, and a conductance of the reentrant TSV model pair, and the capacitance of the reentrant TSV model pair is calculated based on a capacitance of an isolation layer of the reentrant TSV model pair, a capacitance of a substrate of the reentrant TSV model pair, and an equivalent circuit diagram of the reentrant TSV model pair, wherein
the resistance of the reentrant TSV model pair is calculated by:
$${R}_{R - T S V} = \sqrt{{R}_{a c , R - T S V}^{2} + {R}_{d c , R - T S V}^{2}} ,$$
R_{R-TSV} represents the resistance of the reentrant TSV model pair, R_{ac,R-TSV} represents a high-frequency alternating-current resistance of the reentrant TSV model pair and is expressed as:
$${R}_{a c , R - T S V} = \frac{{ρ}_{C u} ( 2 + {α}^{2} )}{4 παδ} ln [ 1 + \frac{2 {c}_{1} {h}_{R - T S V} α}{( 2 {r}_{b} - δ )} ] + \frac{{ρ}_{Cu} {c}_{2} {h}_{R - TSV}}{π [ {r}_{b}^{2} - {( {r}_{b} - δ )}^{2} ]} ,$$
c₁ and c₂ representing a ratio of a height of a cylindrical part in the reentrant TSV body to a height of the reentrant TSV body and a ratio of a height of a tapered part in the reentrant TSV body to the height of the reentrant TSV body, respectively, α=tan θ_{R-TSV}, θ_{R-TSV} representing a taper inclination angle of the tapered part in the reentrant TSV body, h_{R-TSV} representing the height of the reentrant TSV body, r_{b} representing a radius of the cylindrical part in the reentrant TSV body, r_{b}=r_{R-TSV}−αc₂h_{R-TSV}, and r_{R-TSV} representing a radius of a top of the tapered part in the reentrant TSV body, and R_{dc,R-TSV} represents a low-frequency direct-current resistance of the reentrant TSV model pair and is expressed as:
$${R}_{d c , R - T S V} = \frac{{ρ}_{C u} {c}_{1} {h}_{R - T S V} ( 1 + 0.5 \times {α}^{2} )}{π {r}_{T - TSV} ( {r}_{b} + {c}_{1} α {h}_{R - TSV} )} + \frac{{ρ}_{C u} {c}_{2} {h}_{R - T S V}}{π {r}_{b}^{2}} ;$$
in a case that β is less than 0.1, the inductance of the reentrant TSV model pair is calculated by: L_{R-TSV}=L_{in,R-TSV}+L_{ext,R-TSV}, L_{R-TSV} represents the inductance of the reentrant TSV model pair, L_{in,R-TSV} represents an internal inductance of the reentrant TSV model pair and is expressed as:
$${L}_{i n , R - TSV} = \frac{{μ}_{0} {μ}_{Cu} {c}_{1} {h}_{R - TSV}}{8 π} + \frac{{μ}_{0} {μ}_{Cu}}{2 π} [ \frac{{c}_{2} {h}_{R - TSV}}{4} + {h}_{T - TSV} ln \frac{\sqrt{{( {c}_{2} {h}_{R - TSV} )}^{2} + {r}_{b}^{2} + {c}_{2} {h}_{R - TSV}}}{{r}_{a}} + {r}_{a} - \sqrt{{( {c}_{2} {h}_{R - TSV} )}^{2} + {r}_{b}^{2}} + \frac{2 {c}_{2} {h}_{R - TSV} β ( \begin{matrix}{( {c}_{2} {h}_{R - TSV} )}^{2} - ( {c}_{2} {h}_{R - TSV} + {r}_{b} ) \\ ( \sqrt{{{c}_{2} {h}_{R - TSV} )}^{2} + {r}_{b}^{2}} - {r}_{b} )\end{matrix} )}{( \sqrt{{( {c}_{2} {h}_{R - TSV} )}^{2} + {r}_{b}^{2}} - {r}_{b} ) ( 4 {r}_{b} + {c}_{2} {h}_{R - TSV} α )} ] ,$$
and L_{ext,R-TSV} represents an external inductance of the reentrant TSV model pair and is expressed as:
$${L}_{ext , R - TSV} = \frac{{μ}_{0} {μ}_{Cu}}{2 π} [ {c}_{1} {h}_{R - TSV} ln ( \frac{{c}_{1} {h}_{R - TSV} + \sqrt{{h}_{C - TSV}^{2} + {r}_{b}^{2}}}{{r}_{b}} ) + {r}_{b} - \sqrt{{( {c}_{1} {h}_{R - TSV} )}^{2} + {r}_{b}^{2}} ] + \frac{{μ}_{0} {μ}_{Cu}}{2 π} [ {c}_{2} {h}_{R - TSV} ln \frac{\sqrt{{( {c}_{2} {h}_{R - TSV} )}^{2} + {p}_{R - TSV}^{2} + {c}_{2} {h}_{R - TSV}}}{{p}_{R - TSV}} + {p}_{R - TSV} - \sqrt{{( {c}_{2} {h}_{R - TSV} )}^{2} + {p}_{R - TSV}^{2}} + \frac{2 {c}_{2} {h}_{R - TSV} α ( \begin{matrix}{( {c}_{2} {h}_{R - TSV} )}^{2} - ( {c}_{2} {h}_{R - TSV} + {p}_{T - TSV} ) \\ ( \sqrt{{( {c}_{2} {h}_{R - TSV} )}^{2} + {p}_{R - TSV}^{2}} - {p}_{R - TSV} )\end{matrix} )}{\begin{matrix}( \sqrt{{( {c}_{2} {h}_{R - TSV} )}^{2} + {p}_{R - TSV}^{2}} - {p}_{R - TSV} ) \\ ( 4 {p}_{R - TSV} + {c}_{2} {h}_{R - TSV} α )\end{matrix}} ] ,$$
p_{R-TSV} representing a distance between reentrant TSV bodies of the two reentrant TSV models in the reentrant TSV model pair;
the capacitance of the isolation layer of the reentrant TSV model pair is calculated by:
$${C}_{o x , R - T S V} = 2 {πε}_{0} {ε}_{S i {O}_{2}} \times \{ \frac{{c}_{2} {h}_{R - T S V}}{ln ( \frac{{r}_{b} + {t}_{o x}}{{r}_{b}} )} + \frac{α {{t}_{o x} ( {c}_{2} {h}_{R - T S V} )}^{2}}{2 {{r}_{b} ( {r}_{b} + {t}_{ox} ) [ ln ( \frac{{r}_{b} + {t}_{o x}}{{r}_{b}} ) ]}^{2}} \} + \frac{2 {πε}_{0} {ε}_{{SiO}_{2}} {c}_{1} {h}_{R - T S V}}{ln ( \frac{{r}_{b} + {t}_{o x}}{{r}_{b}} )} ;$$
and
the capacitance of the substrate of the reentrant TSV model pair is calculated by:
$${C}_{Si , R - TSV} = 2 π {ε}_{0} {ε}_{Si} \times \{ \frac{{c}_{2} {h}_{R - TSV}}{{cosh}^{- 1} ( \frac{{p}_{R - TSV}^{2}}{2 {( {r}_{b} + {t}_{ox} )}^{2}} - 1 )} - \frac{{α ( {c}_{2} {h}_{R - TSV} )}^{2} {p}_{T - TSV} ( \frac{2 {( {r}_{b} + {t}_{ox} )}^{2} - {p}_{R - TSV}^{2}}{\sqrt{{p}_{R - TSV}^{2} - 4 {( {r}_{b} + {t}_{ox} )}^{2}}} - {p}_{R - TSV} )}{4 {{r}_{b}^{3} [ {cosh}^{- 1} ( \frac{{p}_{R - TSV}^{2}}{2 {( {r}_{b} + {t}_{ox} )}^{2}} - 1 ) ]}^{2} [ \frac{{p}_{R - TSV}^{2}}{2 {( {r}_{b} + {t}_{ox} )}^{2}} - 1 + \sqrt{{( \frac{{p}_{R - TSV}^{2}}{2 {( {r}_{b} + {t}_{ox} )}^{2}} - 1 )}^{2} - 1} ]} \} + \frac{2 {πε}_{0} {ε}_{Si} {c}_{1} {h}_{R - TSV}}{ln ( \frac{{p}_{R - TSV}}{2 {r}_{b}} + \sqrt{{( \frac{{p}_{R - TSV}}{2 {r}_{b}} )}^{2} - 1 )}} .$$

12. The device according to claim 11, wherein the fourth calculated parameter comprises a transmission line characteristic parameter of the first ellipsoidal bump in the cylindrical TSV model pair, a transmission line characteristic parameter of the second ellipsoidal bump in the tapered TSV model pair, and a transmission line characteristic parameter of the third ellipsoidal bump in the reentrant TSV model pair, the transmission line characteristic parameter of the first ellipsoidal bump in the cylindrical TSV model pair comprises a resistance, an inductance, a capacitance, and a conductance of the first ellipsoidal bump in the cylindrical TSV model pair, the transmission line characteristic parameter of the second ellipsoidal bump in the tapered TSV model pair comprises a resistance, an inductance, a capacitance, and a conductance of the second ellipsoidal bump in the tapered TSV model pair, and the transmission line characteristic parameter of the third ellipsoidal bump in the reentrant TSV model pair comprises a resistance, an inductance, a capacitance, and a conductance of the third ellipsoidal bump in the reentrant TSV model pair, wherein
for each of the first ellipsoidal bump in the cylindrical TSV model pair, the second ellipsoidal bump in the tapered TSV model pair, and the third ellipsoidal bump in the reentrant TSV model pair,
a capacitance of the ellipsoidal bump is calculated by:
$${C}_{Bump} = \frac{1}{2} {C}_{Bump 1} ,$$
C_{Bump1} represents a half-capacitance of the ellipsoidal bump, and
$${C}_{Bump 1} = {πε}_{0} {ε}_{underfill} \times \{ \frac{{h}_{Bump}}{{cosh}^{- 1} ( \frac{{p}_{T S V}^{2}}{2 {( {r}_{Bump} )}^{2}} - 1 )} \} ,$$
h_{Bump} representing a height of the ellipsoidal bump, r_{Bump} representing a radius of the ellipsoidal bump, p_{TSV} representing a distance between two TSV bodies in the corresponding TSV model pair, and ε_{underfill} representing a relative permittivity of an underfill.

13. The device according to claim 8, wherein each of the first ellipsoidal bump in the cylindrical TSV model pair, the second ellipsoidal bump in the tapered TSV model pair, and the third ellipsoidal bump in the reentrant TSV model pair has a diameter of 25 micrometers, a radius of 12.5 micrometers, and a height of 18 micrometers.

14. The device according to claim 8, wherein any one TSV body in the cylindrical TSV model pair, in the tapered TSV model pair, and in the reentrant TSV model pair is surrounded by an isolation layer, a material of the isolation layer is silicon dioxide, and a thickness of the isolation layer is 0.1 micrometer.

15. A computer-readable storage medium storing instructions, wherein the instructions, when being executed on a terminal device, cause the terminal device to perform:
building a TSV model set, wherein the TSV model set comprises a cylindrical TSV model pair, a tapered TSV model pair, and a reentrant TSV model pair, wherein
the cylindrical TSV model pair comprises two cylindrical TSV models with a same form, each of the two cylindrical TSV models comprising a cylindrical TSV body with a first end connected to a first ellipsoidal bump through a first pad, and a second end of the cylindrical TSV body being connected to a second pad,
the tapered TSV model pair comprises two tapered TSV models with a same form, each of the two tapered TSV models comprising a tapered TSV body with a first end connected to a second ellipsoidal bump through a third pad, and a second end of the tapered TSV body being connected to a fourth pad, and
the reentrant TSV model pair comprises two reentrant TSV models with a same form, each of the two reentrant TSV models comprising a reentrant TSV body with a first end connected to a third ellipsoidal bump through a fifth pad, and a second end of the reentrant TSV body being connected to a sixth pad;
calculating transmission line characteristic parameters of the cylindrical TSV model pair, the tapered TSV model pair, the reentrant TSV model pair, as well as the first ellipsoidal bump, the second ellipsoidal bump, and the third ellipsoidal bump, respectively, to obtain a first calculated parameter, a second calculated parameter, a third calculated parameter, and a fourth calculated parameter;
performing simulations on the cylindrical TSV model pair, the tapered TSV model pair, the reentrant TSV model pair, as well as the first ellipsoidal bump, the second ellipsoidal bump, and the third ellipsoidal bump, respectively, to obtain a first simulation parameter, a second simulation parameter, a third simulation parameter, and a fourth simulation parameter;
calculating a parameter difference between the first calculated parameter and the first simulation parameter, a parameter difference between the second calculated parameter and the second simulation parameter, a parameter difference between the third calculated parameter and the third simulation parameter, and a parameter difference between the fourth calculated parameter and the fourth simulation parameter; and
outputting the TSV model set in response to all the parameter differences meeting an error requirement.
